(19) United States
(12) Patent Application Publication
(10) Pub. No.: US 2024/0221722 A1
(43) Pub. Date: Jul. 4, 2024

(54) EYEWEAR DEVICE AND METHOD OF USE

(71) Applicant: Solos Technology Limited, Hong Kong (HK)

(72) Inventors: Wai Kuen CHEUNG, New Territories (HK); Kwok Wah LAW, New Territories (HK); Chi Sum YU, Kowloon (HK); Kwun Lam TAI, Kowloon (HK); Kenneth FAN, Somerville, MA (US)

(73) Assignee: Solos Technology Limited, Hong Kong (HK)

(21) Appl. No.: 18/403,008

(22) Filed: Jan. 3, 2024

Related U.S. Application Data
(60) Provisional application No. 63/436,841, filed on Jan. 3, 2023.

(51) Int. Cl. G10L 15/00; G02B 27/01; G02C 11/00; G10L 15/06; G10L 15/26

(52) U.S. Cl. CPC G10L 15/005; G02B 27/0172; G02B 27/0176; G02C 11/10; G10L 15/063; G10L 15/26; G02B 2027/0178

(57) ABSTRACT

An eyewear device having an eyewear frame including a first unidirectional audio input device configured to receive a communication datum from an individual in communication with a user, a second unidirectional audio input device configured to receive user speech from the user. a user input device configured to control whether the eyewear frame is in a first mode or a second mode and at least one audio output device located on at least one temple of the eyewear frame, and a computing device configured to, receive a user input from the user input device. in the first mode, receive the communication datum and modify the communication datum to generate a modified communication datum and in the second mode, receive the user speech and transmit the user speech to a remote device.

### CROSS-REFERENCE TO RELATED APPLICATIONS

This application claims the benefit of priority of U.S. Provisional Patent Application Ser. No. 63/436,841 filed on Jan. 3, 2023, and titled “Hearing Assist and Language Translation in Smart Glasses Systems, Apparatuses, and Methods” which is incorporated by reference herein in its entirety.

### FIELD OF THE INVENTION

The present invention generally relates to the field of eyewear devices. In particular, the present invention is directed to an electronic eyewear device capable of providing information.

### BACKGROUND

The pace of modem life moves at a fast pace. A person is often placed under the constraint of time and is placed in situations where his or her hands are occupied, and information is not accessible to the person. This can present a problem. Currently available eyewear such as prescription glasses, e.g., prescription reading glasses or prescription sunglasses are expensive and are not readily reconfigured to different user's needs. This can present a problem.

### SUMMARY OF THE DISCLOSURE

In an aspect, a smart eyewear device system is provided. The smart eyewear device system includes an eyewear device. The eyewear device includes a first unidirectional audio input device configured to receive a communication datum from an individual in communication with a user, a second unidirectional audio input device configured to receive user speech from the user, a user input device configured to control whether the eyewear frame is in a first mode or a second mode, and at least one audio output device located on at least one temple of the eyewear device. The smart eyewear device system also includes a computing device configured to receive a user input from the user input device, receive the communication datum from the first unidirectional audio input device in the first mode, and receive the user speech from the second unidirectional audio input device and transmit the user speech in the second mode. Additionally, the smart eyewear device system includes a remote device communicatively connected to the eyewear device and a cloud server. The remote device is configured to receive the communication datum and the user speech from the computing device.

In an aspect an eyewear device is described. An eyewear device includes an eyewear frame, the eyewear frame including an eyewear frame including a first unidirectional audio input device configured to receive a communication datum from an individual in communication with a user, a second unidirectional audio input device configured to receive user speech from the user, a user input device configured to control whether the eyewear frame is in a first mode or a second mode and at least one audio output device located on at least one temple of the eyewear frame. The eyewear device further includes a computing device communicatively connected to the eyewear device; the computing device configured to receive a user input from the user input device, in the first mode, receive the communication datum from the first unidirectional audio input device and modify the communication datum to generate a modified communication datum and in the second mode, receive the user speech from the second unidirectional audio input device and transmit the user speech to a remote device.

In another aspect, a method of use of an eyewear device is described. The method includes receiving, by a computing device communicatively connected to the eyewear device, a user input from an input device located on an eyewear frame of the eyewear device, wherein the eyewear frame includes a first unidirectional audio input device configured to receive a communication datum associated with an individual in communication with the user, a second unidirectional audio input device configured to receive a user speech from the user and the input device, the input device configured to control whether the eyewear frame is in a first mode or a second mode. The method further includes in the first mode, receiving, by the computing device, receiving the communication datum from the first unidirectional audio input device and modifying the communication datum to generate a modified communication datum and in the second mode, receiving, by the computing device, receiving the user speech from the second unidirectional audio input device and transmitting the user speech to a remote device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a system block diagram of an exemplary embodiment of an eyewear device according to the subject disclosure;

FIG. 2 illustrates a system block diagram of yet another exemplary embodiment of an eyewear device according to the subject disclosure;

FIG. 3 illustrates hardware components block diagram, according to embodiments of the invention.

FIG. 4 illustrates an exemplary eyewear device and corresponding audio beam directions, according to embodiments of the invention;

FIG. 5 illustrates an exemplary system illustrating a hearing mode according to embodiments of the invention is described;

FIG. 6 illustrates an exemplary system illustrating a phone mode according to embodiments of the invention;

FIG. 7A illustrates a signal processing algorithm for hearing mode, according to embodiments of the invention;

FIG. 7B illustrates processing flow for hearing mode, according to embodiments of the invention.

FIG. 7C illustrates mobile terminal real-time speech translation, according to embodiments of the invention.

FIG. 8 illustrates signal processing algorithms for phone mode, according to embodiments of the invention.

FIG. 9 illustrates switching logic between phone and hearing modes, according to embodiment, of the invention.

FIG. 10 illustrates a block diagram of smart glasses electronic hardware components, according to embodiments of the invention.

FIG. 11 is a block diagram of exemplary embodiment of a machine learning module;

FIG. 12 is a diagram of an exemplary embodiment of a neural network;

FIG. 13 is a block diagram of an exemplary embodiment of a node of a neural network;

FIG. 14 is a flow diagram illustrating an exemplary embodiment of a method of use for an eyewear device; and

FIG. 15 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for an eyewear device. In an embodiments, eyewear device includes one or more audio input devices configured to receive a communication from an individual and modify the communication to assist a user in receiving the communication. In an embodiments, communications may be modified to amplify sounds, to translate communications and/or any other modification that may facilitate a user's understanding of the communication.

In the following detailed description of embodiments of the invention, reference is made to the accompanying drawings, in which like references indicate similar elements, and in which is shown by way of illustration, specific embodiments in which the invention may be practiced. These embodiments are described in sufficient detail to enable those of skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

In one or more embodiments, methods, apparatuses, and systems are described, that provide music streaming, telephone call support, speech signal amplification for users with hearing loss, and language translation. In various embodiments, speech signals are captured from the front of the user, the glasses process and amplify the speech and then output the amplified signal to smart glasses speaker. Such functionality helps mild hearing loss users hear better. In various embodiments, real-time language translation functionality of provided by the glasses. Speech signals are captured, typically from the front, and are translated from one language to another language in real-time (e.g. and without limitation English to Chinese). The translated language speech signals are then output to smart glasses speaker(s). Such functionality helps a user to better understand content of speech from a speaker of a different language.

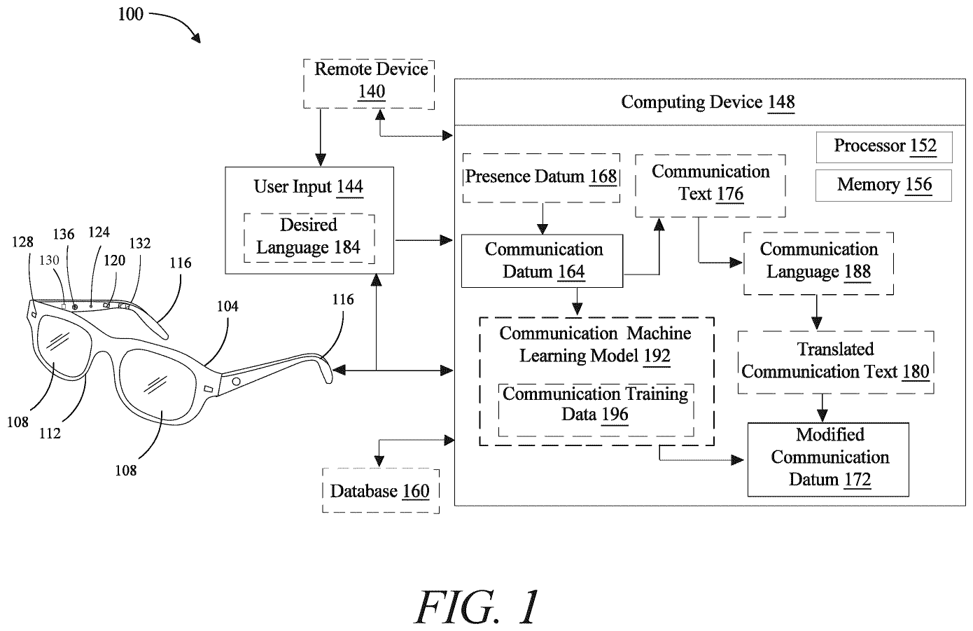

Referring now to FIG. 1, an exemplary embodiment of an eyewear device 100 is described. In one or more embodiments, eyewear device 100 includes an eyewear frame 104. “Eyewear frame” for the purposes of this disclosure is a structure that surrounds or encloses eyewear device 100 and is configured to be worn on the face of a user. For example, and without limitation, eyewear frame 104 may include a structure having similar shape to an ordinary eyeglasses frame. In one or more embodiments, eyewear frame 104 may include any necessary structure to contain optical lenses 108. In one or more embodiments, the optical lenses 108 may allow correction of a vision of the user through the user of eyewear device 100. “Optical lens” for the purposes of this disclosure is a curved transparent piece of material that is designed to focus or refract light. In one or more embodiments, optical lens 108 may contain a predetermined curvature wherein the predetermined curvature may be used to refract or focus light based on the given needs of a user. In one or more embodiments, the curvature of optical lens 108 may be measured based on its focal length wherein the focal length may be measured as the distance between optical lens 108 and a focal point on the lens. In one or more embodiments, optical lens may include a blue light filter wherein the blue light filter may be configured to limit the amount of blue limit emitted through optical lens. In or more embodiments, optical lens may contain one or more filter to reduce and/or eliminate light. In one or more embodiments, differing users may contain differing focal lengths based on their respective needs. “User” for the purposes of this disclosure refers to an individual who is operating or wearing eyewear device 100. User may include any individual who is capable of operating eyewear device 100. In one or more embodiments, optical lens 108 may be configured to the needs of a user, such as for example, based on the user's given eyeglasses prescription.

With continued reference to FIG. 1, eyewear frame 104 may include a frame front 112 wherein frame front 112 refers to the portion of eyewear frame 104 that holds the optical lenses 108. In one or more embodiments, frame front 112 may contain a rim to surround and hold each optical lenses 108. In one or more embodiments, frame front 112 may include two rims wherein each rim may be configured to hold a separate optical lens 108. In one or more embodiments, each rim and corresponding optical lens 108 may correspond to each eye of a user. In one or more embodiments, eyewear frame 104 may include one or more temples 116 extending from frame front 112. “Temple” also referred to as “arms,” for the purposes of this disclosure is an element that extends from frame front 112 of a pair of glasses that is configured to rest on a user's ear and provide support for the eyeglasses on a user's frame. In one or more embodiments, temples 116 may include elongated components that are configured to provide support of eyewear device 100 on the face of a user. In one or more embodiments, while in use each temple 116 may rest on the top of an ear of the user similar to how a pair of eyeglasses may be worn. In one or more embodiments, each temple 116 may include template tips, wherein the temple 116 tips are curved ends situated at an end of each template and configured to provide stability of eyewear device 100 on the face of a user. In one or more embodiments, temple 116 tips may prevent or minimize movement of eyewear device 100 in situations in which a user is moving their head in various directions.

With continued reference to FIG. 1, in one or more embodiments, eyewear frame 104 may include one or more sensors. As used in this disclosure, a “sensor” is a device that is configured to detect an input and/or a phenomenon and transmit information related to the detection. For example, and without limitation, a sensor may transduce a detected charging phenomenon and/or characteristic, such as, and without limitation, temperature, voltage, current, pressure, and the like, into a sensed signal such as a voltage with respect to a reference. Sensor may detect a plurality of data. A plurality of data detected by sensor may include, but is not limited to light intensity, temperature, noise, audio, video and the like. In one or more embodiments, and without limitation, sensor may include a plurality of sensors. In one or more embodiments, and without limitation, sensor may include an optical or image sensor such as a camera, a CMOS detector, a CCD detector, a video camera, a photodiode, a photovoltaic cell, a photoconductive device, a thermal and/or infrared camera, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor may be a contact or a non-contact sensor. Signals may include electrical, electromagnetic, visual, audio, radio waves, or another undisclosed signal type alone or in combination.

With continued reference to FIG. 1, sensor may include a plurality of independent sensors. Independent sensors may include separate sensors measuring physical that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of sensor to detect phenomenon may be maintained.

Still referring to FIG. 1, sensor may include a motion sensor. A “motion sensor”, for the purposes of this disclosure, refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor may include torque sensor, gyroscope, accelerometer, torque sensor, magnetometer, inertial measurement unit (IMU), pressure sensor, force sensor, proximity sensor 124, displacement sensor, vibration sensor, among others.

With continued reference to FIG. 1, sensor may include a plurality of sensing devices, such as, but not limited to, temperature sensors, humidity sensors, accelerometers, electrochemical sensors, gyroscopes, magnetometers, inertial measurement unit (IMU), pressure sensor, proximity sensor 124, displacement sensor, force sensor, vibration sensor, air detectors, hydrogen gas detectors, and the like. Sensor may be configured to detect a plurality of data, as discussed further below in this disclosure. A plurality of data may be detected from sensor.

With continued reference to FIG. 1, sensor may include a sensor suite 120 which may include a plurality of sensors that may detect similar or unique phenomena. For example, in a non-limiting embodiment, a sensor suite 120 may include a plurality of gyroscopic sensors, accelerometers and the like to determine the posture of an individual. In one or more embodiments, eyewear device 100 may include a sensor suite 120 wherein the sensor suite 120 is configured to determine the posture of a user. In one or more embodiments, sensor suite 120 may include sensors such as but not limited to, gyroscopic sensors, proximity sensors 124, accelerometers, magnetometers, Inertial measurement units and the like. “Proximity sensor” for the purposes of this disclosure is a sensor that can detect the presence of an object. For example, and without limitation, proximity sensor may include an ultrasonic sensor, wherein the ultrasonic sensor may indicate how far away an object may be. In one or more embodiments, proximity sensor 14 may include but is not limited to, inductive sensors, ultrasonic sensors, capacitive sensors, photoelectric sensors, laser sensors, infrared sensors and/or any other sensor that may be used to determine the presence of a user or an individual. Eyewear device 100 may include a plurality of sensors in the form of individual sensors or a sensor suite 120 working in tandem or individually. A sensor suite 120 may include a plurality of independent sensors, as described in this disclosure, where any number of the described sensors may be used to detect any number of physical or electrical quantities associated with a charging connection. Independent sensors may include separate sensors measuring physical or electrical quantities that may be powered by and/or in communication with circuits independently, where each may signal sensor output to a control circuit. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained.

With continued reference to FIG. 1, sensor is configured to transmit a sensor output signal representative of sensed information. As used in this disclosure, a “sensor signal” is a representation of a sensed information that sensor may generate. A sensor signal may include any signal form described in this disclosure, for example digital, analog, optical, electrical, fluidic, and the like. In some cases, a sensor, a circuit, and/or a controller may perform one or more signal processing steps on a signal. For instance, sensor, circuit, and/or controller may analyze, modify, and/or synthesize a signal in order to improve the signal, for instance by improving transmission, storage efficiency, or signal to noise ratio.

With continued reference to FIG. 1, exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, eyewear frame 104 and/or sensor may include a proximity sensor 124. In one or more embodiments, proximity sensor 124 may include any sensor as described in this disclosure that is capable of determining the presence of a user. In one or more embodiments, proximity sensor 124 may be used to determine eyewear device 100 is currently being worn by a user. In one or more embodiments, various actions and/or processes initiated by eyewear device 100 may be automated and/or dependent on the presence of a user. In one or more embodiments, proximity sensor 124 may be located on an inner surface of one or more temples 116 on eyewear frame 104. In one or more embodiments, in instances where eyewear frame 104 is situated on the face of user, proximity sensor 124 may be used to determine if an object (the head of a user) is present. In one or more embodiments, various processes of eyewear device 100 may only be useful in instances in which the user is currently wearing eyewear device 100. In one or more embodiments, proximity sensor 124 may be configured to determine the presence of a nearby object to a given predetermined distance to determine if a user is currently wearing eyewear device 100. In one or more embodiments, eyewear frame 104 may contain more than one proximity sensors 124 wherein one proximity sensor 124 may be located on either temple 116 of eyewear frame 104. In one or more embodiments, proximity sensor 124 may be used to begin, stop and/or resume functionalities on eyewear device 100 as described in further detail below. In one or more embodiments, eyewear device 100 may include a second proximity sensor 124, wherein the second proximity sensor 124 is configured to determine the presence of an individual in communication with user. In one or more embodiments, an individual may be physically present in front of and/or near user and engage in conversation or communication with user. In one or more embodiments, second proximity sensor 124 may be located on frame front 112 wherein the presence of an object or individual may indicate to eyewear device 100 to begin receipt of audio data. In one or more embodiments, second proximity sensor 124 may be used simultaneously with a sound sensor, such as audio input device wherein the presence of an object in front of eyewear device 100 as well as detection of a sound may indicate that an individual is present in front of user.

With continued reference to FIG. 1, eyewear device 100 and/or eyewear frame 104 may include one or more sensors, such as any sensors as described above. In one or more embodiments, each sensor may serve a distinct and unique purpose. In one or more embodiments, more than one sensor may work together to provide a single end result as described in further detail below. In one or more embodiments, one or more sensors may be used to receive information which may then be used by computing device for further processing as described in further detail below.

With continued reference to FIG. 1, eyewear frame 104 and/or eyewear device 100 may include an audio input device. “Audio input device” for the purposes of this disclosure is a device that is capable of capturing a sound which may then be converted into digital signal. Audio input device may include a microphone. As used in this disclosure, a “microphone” is any transducer configured to transduce pressure change phenomenon to a signal, for instance a signal representative of a parameter associated with the phenomenon. Microphone, according to some embodiments, may include a transducer configured to convert sound into electrical signal. Exemplary non-limiting microphones include dynamic microphones (which may include a coil of wire suspended in a magnetic field), condenser microphones (which may include a vibrating diaphragm condensing plate), and a contact (or conductance) microphone (which may include piezoelectric crystal material). Microphone may include any microphone for transducing pressure changes, as described above; therefore, microphone may include any variety of microphone, including any of: condenser microphones, electret microphones, dynamic microphones, ribbon microphones, carbon microphones, piezoelectric microphones, fiber-optic microphones, laser microphones, liquid microphones, microelectromechanical systems (MEMS) microphones, and/or a speaker microphone.

With continued reference to FIG. 1, audio input device and/or microphone may be configured to receive an audio signal. An “audio signal,” as used in this disclosure, is a representation of sound. In some cases, an audio signal may include an analog electrical signal of time-varying electrical potential. In some embodiments, an audio signal may be communicated (e.g., transmitted and/or received) by way of an electrically transmissive path (e.g., conductive wire), for instance an audio signal path. Alternatively or additionally, audio signal may include a digital signal of time-varying digital numbers. In some cases, a digital audio signal may be communicated (e.g., transmitted and/or received) by way of an optical fiber, at least an electrically transmissive path, and the like. In some cases, a line code and/or a communication protocol may be used to aid in communication of a digital audio signal. Exemplary digital audio transports include, without limitation, Alesis Digital Audio Tape (ADAT), Tascam Digital Interface (TDIF), Toshiba Link (TOSLINK), Sony/Philips Digital Interface (S/PDIF), Audio Engineering Society standard 3 (AES3), Multichannel Audio Digital Interface (MADI), Musical Instrument Digital Interface (MIDI), audio over Ethernet, and audio over IP. Audio signals may represent frequencies within an audible range corresponding to ordinary limits of human hearing, for example substantially between about 20 and about 20,000 Hz. According to some embodiments, an audio signal may include one or more parameters, such as without limitation bandwidth, nominal level, power level (e.g., in decibels), and potential level (e.g., in volts). In some cases, relationship between power and potential for an audio signal may be related to an impedance of a signal path of the audio signal. In some cases, a signal path may single-ended or balanced. In one or more embodiments, microphone may be configured to transduce an environmental noise to an environmental noise signal. In some cases, environmental noise may include any of background noise, ambient noise, aural noise, such as noise heard by a user's ear, and the like. Additionally or alternatively, in some embodiments, environmental noise may include any noise present in an environment, such as without limitation an environment surrounding, proximal to, or of interest/disinterest to a user. Environmental noise may, in some cases, include substantially continuous noises, such as a drone of an engine. Alternatively or additionally, in some cases, environmental noise may include substantially non-continuous noises, such as spoken communication or a backfire of an engine. Environmental noise signal may include any type of signal, for instance types of signals described in this disclosure. For instance, an environmental noise signal may include a digital signal or an analog signal.

With continued reference to FIG. 1, in one or more embodiments, audio input device may be located on eyewear frame 104. In one or more embodiments, audio input device may contain more than one audio input device. In one or more embodiments, audio input device may include a first audio input device 128 and second audio input device 130. In one or more embodiments, first audio input device 128 may be configured to receive audio from an individual in communication with user. “Individual” for the purposes of this disclosure is a person who may be communicating with a user. For example, and without limitation, individual may include a person within the physical presence of user and communicating with user. In one or more embodiments, individual may include a person communicating with user using one or more computing devices, such as a smart phone. In one or more embodiments, an individual may be physically present in front of a user wherein first audio input device 128 may be configured to receive audio communications and/or noises from the individual. In one or more embodiments, audio input device and/or first audio input device 128 may include a unidirectional audio input device. “Unidirectional audio input device” for the purposes of this disclosure is an audio input device that is configured to capture sound from one direction, as opposed to two or more directions. In one or more embodiments, unidirectional audio input device may be configured to receive an audio from a specific direction and minimize audio from other directions. In one or more embodiments, unidirectional audio input device may be configured to capture only those sounds that are within the line of sight of user. In one or more embodiments, unidirectional audio input device may be located on frame front 112 wherein only those sounds emitted within a line of sight of user may be captured. In one or more embodiments, audio input device may include a first unidirectional audio input device wherein the first unidirectional audio input device is configured to receive communication datum from the individual in communication with the user. In one or more embodiments, audio input device may include an omni directional microphone, a cardioid, a super cardioid, a hyper cardioid and/or any other audio input devices 128. In one or more embodiments, audio input device and/or first unidirectional audio input device may be situated on frame front 112 wherein only sounds within the line of sight of a user are captured. In one or more embodiments, eyewear frame 104 may include first unidirectional audio input device wherein first unidirectional audio input device is configured to receive communication datum 164 associated with an individual in communication with the user. Communication datum 164 will be described in further detail below.

With continued reference to FIG. 1, eyewear device 100 and/or audio input device may include a second audio input device 130 wherein the second audio input device 130 may be consistent with audio input device. In one or more embodiments, second audio input device 130 may be configured to capture the sounds of a user. In one or more embodiments, second audio input device 130 may be configured to receive user speech. “User speech” for the purposes of this disclosure is a communication made by the user. For example, and without limitation, a user may speak while wearing eyewear device 100 wherein second audio input device 130 may be configured to receive the speech. In one or more embodiments, user speech may include any sounds emitted by a user while wearing, and/or interacting with, eyewear device 100. In one or more embodiments, a user may speak while wearing eyewear device 100 wherein second audio input device 130 may be configured to capture the sounds and convert them into a digital signal. In one or more embodiments, second audio input device 130 may be used as a microphone for phone calls, for recording and the like. In one or more embodiments, second audio input device 130 may include a second unidirectional audio input device that is directed towards the user. In one or more embodiments, second audio input device 130 may be configured to receive communications from a user. In one or more embodiments, second unidirectional audio input device may be configured to receive communications from a user and transmit the communications to a remote device 140 as described in this disclosure. In one or more embodiments, second unidirectional audio input device may include unidirectional audio input device. In one or more embodiments, second audio input device 130 may be used for phone calls and/or audio recordings wherein communications by a user, such as user speech, may be captured and transmitted to a remote device 140 such as a smart phone.

With continued reference to FIG. 1, eyewear frame 104 may include at least one audio output device 132. “Audio output device” for the purposes is this disclosure is a device capable of converting digital sound waves into audible sound. In one or more embodiments, audio output device 132 may include a speaker, earphones, headphones and the like. In one or more embodiments, audio output device 132 may be situated on an inner surface of temple 116 eyewear frame 104. In one or more embodiments, audio output device 132 may be situated on temple 116 of eyewear frame 104. In one or more embodiments, location of audio output device 132 may allow for a smaller distance between the user's ears and audio output device 132. In one or more embodiments, sound emitted from audio output device 132 may be received by the user. In one or more embodiments, an audio output device 132 may be located on each temple 116 wherein a user may receive sound to both ears. In one or more embodiments, speaker may be configured to convert a digital signal into sound as described in further detail below. In one or more embodiments, audio output device may include bone conduction headphones. “Bone conduction headphones” for the purposes of this disclosure is an audio output device capable of transmitting sounds through vibrations that are emitted to a user's skull. In one or more embodiments, bone conduction headphones may transmit vibrations to a user's skull, such as for example, their cheekbones, wherein the vibrations may travel through a user's skull and into their inner ear. The vibrations are then received through the inner ear as sounds. In one or more embodiments, bone conduction headphones may contain a transducer that is configured to generate vibrations. In one or more embodiments, the transducer may be in contact with a user's skin wherein the transducer can properly transmit vibrations to a user's skill. In one or more embodiments, transducer may be responsible for converting electric sound signals into vibrations. In one or more embodiments, bone conduction headphones may be located on each or temple 116 wherein the temples 116 are in contact with a user's skull. In one or more embodiments, bone conduction headphones may allow for increased awareness of a user's surroundings wherein a user may receive sounds traditionally through their ear while bone conduction headphones may simultaneously transmit sounds through vibrations.

With continued reference to FIG. 1, eyewear device 100 and/or eyewear frame 104 may include one or more user input devices 136 which may allow a user to communicate with a computing device communicatively connected to eyewear device 100. In one or more embodiments, user input devices 136 may include a push button, more than one push buttons, a touch sensor, a touch bar, a switch, a dial and the like. In one or more embodiments, each of the one or more user input devices 136 may perform a separate function. For example, and without limitation, a switch may power eyewear device 100 on and off, whereas a push button may be associated with a command such as increasing the volume of audio output device 132. In one or more embodiments, each user input device 136 may be associated with a command. “Command” for the purposes of this disclosure is a specific set of instructions given to a computing device to perform an action. For example, and without limitation, command may include instructions to play an audio, stop an audio, increase the volume out of audio output device 132 and the like. In one or more embodiments, each input may contain a predetermined command that instructs computing device to perform an action. In one or more embodiments, user input device 136 may be communicatively connected to eyewear device 100. Examples of user input devices 136 include, but are not limited to, an alpha-numeric user input device 136 (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. In one or more embodiments, user input device 136 may include a remote device 140 that is communicatively connected to eyewear device 100. In one or more embodiments, remote device 140 may include a smartphone, a tablet, a computer, a laptop computer and/or any other digital device capable of sending and/or receiving signals. In one or more embodiments, a user may, though remote device 140 provide a user input 144 to eyewear device 100. In one or more embodiments, user input devices 136 may include push buttons, switches and the like. In one or more embodiments, push buttons and/or any other user input devices 136 may contain preconfigured instructions configuring a computing device in communication with eyewear device 100 to perform one or more actions. In one or more embodiments, user input device 136 may be configured to control weather eye frame 104 is in first mode or second mode. In one or more embodiments, user input 136 may receive an input from user wherein the input may cause a switch between first mode and second mode. This will be described in further detail below.

With continued reference to FIG. 1, in one or more embodiments, user input device 136 may control an input from first audio input device 128 and/or second audio input device 130. In one or more embodiments, receipt of communication datum from first audio input device may be controlled by a user input 144 through user input device 136. In one or more embodiments, receipt of user speech from second audio input device 130 may be controlled by user input 144 through user input device 136. In one or more embodiments, interaction of input device 130, such as the pressing of a push button may control receipt of first audio input device 128 and/or second audio input device 130. In one or more embodiments, each interaction of user input device 136 may be associated with a command. In one or more embodiments, a first interaction of audio input device may be associated with a first mode, wherein the first mode is configured to receive communication datum from audio input device. In one or more embodiments, in a first mode, second audio input device 130 may be disabled wherein user speech is not received from second audio input device 130. In one or more embodiments, a second interaction of user input device 136 may be associated with a second mode wherein in a second mode, the user speech is received by second audio input device 130. In one or more embodiments, in a second mode, the first audio input device 128 is disabled wherein communication datum is no longer received. In one or more embodiments, each interaction of user input device 136, such as for example, the pressing of a button, may be associated with a mode on eyewear device 100. “Mode” for the purposes of this disclosure is a specific set of commands for eyewear device 100 to perform one or more actions. For example, and without limitation, a mode may include commands to receive communication datum 164 and not receive user speech, whereas another mode may include commands to receive user speech and not communication datum 164. In one or more embodiments, an indication that eyewear frame 104 is in a particular mode may include an indication that computing device 148 is configured to perform a particular set of tasks. For example, and without limitation, in instances in which eyewear frame 104 is in a first mode, computing device may be configured to perform actions in accordance with first mode. In one or more embodiments, modes may be preconfigured on eyewear device 100 wherein interaction of user input device 136 may signal to a computing device to switch between one or more modes.

With continued reference to FIG. 1, eyewear device 100 includes a computing device 148. Eyewear device 100 includes a processor 152. Processor 152 may include, without limitation, any processor 152 described in this disclosure. Processor 152 may be included in a and/or consistent with computing device 148. Computing device 148 may include any computing device as described in this disclosure, including without limitation a microcontroller, microprocessor, digital signal processor (DSP) and/or system on a chip (SoC) as described in this disclosure. Computing device 148 may include, be included in, and/or communicate with a mobile device such as a mobile telephone or smartphone. Computing device 148 may include a single computing device 148 operating independently or may include two or more computing devices operating in concert, in parallel, sequentially or the like; two or more computing devices may be included together in a single computing device 148 or in two or more computing devices. Computing device 148 may interface or communicate with one or more additional devices as described below in further detail via a network interface device. Network interface device may be utilized for connecting computing device 148 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device 148. Computing device 148 may include but is not limited to, for example, a computing device 148 or cluster of computing devices in a first location and a second computing device 148 or cluster of computing devices in a second location. Computing device 148 may include one or more computing devices dedicated to data storage, security, distribution of traffic for load balancing, and the like. Computing device 148 may distribute one or more computing tasks as described below across a plurality of computing devices of computing device 148, which may operate in parallel, in series, redundantly, or in any other manner used for distribution of tasks or memory 156 between computing devices. Computing device 148 may be implemented, as a non-limiting example, using a “shared nothing” architecture.

With continued reference to FIG. 1, computing device 148 may be designed and/or configured to perform any method, method step, or sequence of method steps in any embodiment described in this disclosure, in any order and with any degree of repetition. For instance, computing device 148 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 148 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 148 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, eyewear device 100 includes a memory 156 communicatively connected to processor 152. As used in this disclosure, “communicatively connected” means connected by way of a connection, attachment, or linkage between two or more relate which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device 148. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 1, eyewear device 100 may be communicatively connected to a database 160. Database 160 may be implemented, without limitation, as a relational database, a key-value retrieval database such as a NOSQL database, or any other format or structure for use as database that a person skilled in the art would recognize as suitable upon review of the entirety of this disclosure. Database may alternatively or additionally be implemented using a distributed data storage protocol and/or data structure, such as a distributed hash table or the like. Database 160 may include a plurality of data entries and/or records as described above. Data entries in database may be flagged with or linked to one or more additional elements of information, which may be reflected in data entry cells and/or in linked tables such as tables related by one or more indices in a relational database. In one or more embodiments, database 160 may include a network of one or more remote servers wherein the remote servers are configured to provide computing services. In one or more embodiments, database 160 may include one or more computing devices, such as any computing devices, as described in this disclosure that may be accessed and/or used to process one or more steps as described in this disclosure. Persons skilled in the art, upon reviewing the entirety of this disclosure, will be aware of various ways in which data entries in database may store, retrieve, organize, and/or reflect data and/or records.

With continued reference to FIG. 1, in one or more embodiments, computing device 148 is configured to receive a user input 144 (as described in further detail below) from user input device 136. In one or more embodiments, user input 144 may include interaction of user input device 136 such as the pressing of a button, the flipping of a switch and the like. In one or more embodiments, user input may allow for a switching between a first mode and a second mode wherein in the first mode, the computing device 148 is configured to receive the communication datum 164 and modify the communication datum to generate a modified communication datum 172, and in the second mode, the computing device 148 is configured to receive the user speech and transmit the user speech to a remote device 140. In one or more embodiments, actions and/or processes performed by computing device 148 may be dependent on each mode, wherein computing device 148 may receive a mode prior to performing one or more actions. In one more embodiments, computing device 148 may receive communication datum 164, generate communication text 176, generate translated communication text 180, receive and/or generate modified communication datum 176 and the like upon receipt of an input from user input device 136 or an indication that the eyewear device 100 is in a first mode. In one or more embodiments, computing device 148 may receive user speech and transmit user speech to remote device upon the receipt of user input 144 from user input device 136 and/or upon indication eyewear device is in a second mode. In one or more embodiments, one or more computing process as described below may be instantiated following user input 144 by input device 144. In one or more embodiments, computing device 148 is configured to receive user input 144 from user input device 136. In the first mode, computing device 148 is configured to receive the communication datum from the first unidirectional audio input device 128 and modify the communication datum 164 to generate a modified communication datum 172. In the second mode, computing device 148 is configured to receive the user speech from the second unidirectional audio input device 130 and transmit the user speech to remote device 140. In one or more embodiments, computing device 148 may configured to switch from the second mode to the first mode as a function of a termination of a voice call. A voice call may include but is not limited to cell calls, VOIP calls, voice chats, etc. In one or more embodiments, a voice call may be associated with a video chat. In one or more embodiments, computing device may be configured to switch from first mode to second mode upon receipt of a voice call, video call and the like. In one or more embodiments, remote device q44 may include a device capable of making and receiving calls wherein receipt of a phone call or initiation of a phone call may initiate a switch from first mode to second mode, and termination of the voice call may result in a switch back from second more to first mode.

With continued reference to FIG. 1, computing device 148 may be configured to receive at least a communication datum 164. In one or more embodiments, communication datum 164 may be received in a first mode and/or upon user input 144 by user input device 136. “Communication datum” for the purposes of this disclosure is a sound captured by audio input device in the form of a digital signal. For example, and without limitation, communication datum 164 may include a recording of the surrounding environment of eyewear device 100, a sound emitted by an individual in communication with user, a sound of a truck, a sound of birds chirping and the like, a sound emitted by user and the like. In one or more embodiments, audio input device may be configured to receive sounds from a surrounding environment and transmit them to computing device 148. In one or more embodiments, computing device 148 may be configured to continuously receive communication datum 164. For example, and without limitation, computing device 148 may be configured to continuously capture the surrounding environment of eyewear device 100. In one or more embodiments, audio input device such as first audio input device 128 may be located on eyewear frame 104 wherein communication datum 164 may contain a speech or noise from a surrounding environment of user. In one or more embodiments, audio input device may be communicatively connected to eyewear device 100 wherein communication datum 164 may be received from a remote device 140. In one or more embodiments, communication datum 164 received by audio input device may include a current phone call and/or a prerecorded audio transmitted from remote device 140 such as but not limited to music, podcasts and the like. In one or more embodiments, communication datum 164 may include any audio transmitted by remote device 140 and received by eyewear device 100. In one or more embodiments, computing device 148 may be configured to receive communication datum 164 upon the occurrence of a predetermined event. For example, and without limitation, computing device 148 may be configured to receive communication datum 164 only when eyewear device 100 is worn by a user. In one or more embodiments, communication datum 164 may be received upon the occurrence of an event. An event may include a specific action by the user such as an input through one or more user input devices 136. In one or more embodiments, an event may include an indication that eyewear device 100 is in first mode. An event may further include one or more occurrences associated with eyewear device 100. This may include, but it is not limited to, detection of movement of eyewear device 100. detection that eyewear device 100 is currently being worn and the like. In one or more embodiments, computing device 148 may be configured to receive communications datum as a function of user input 144 wherein user input 144 may indicate whether computing device 148 should receive or should not receive communication datum 164. In one or more embodiments, an event may include selection of a button on eyewear frame 104. In one or more embodiments, communication datum may be received from first audio input device a 128 and/or a second audio input device 130. In one or more embodiments, an input made by user input device 136 may indicate whether communication datum should be received from first audio input device 128 or second audio input device 130.

With continued reference to FIG. 1, in one or more embodiments, computing device 148 may be configured to determine the presence of an individual using proximity sensor 124 as described above wherein computing device 148 may be configured to receive communication datum 164 based on whether the user is currently present. In one or more embodiments, proximity sensor 124 may be configured to receive presence datum 168. “Presence datum” for the purposes of this disclosure is information received from proximity sensor 124 that may be used to determine if eyewear device 100 is currently being worn by the user. In one or more embodiments, presence datum 168 may include various light intensities, changes in electromagnetic radiation, changes in distance and the like. Computing device 148 may receive presence datum 168 and determine if an individual is wearing eyewear device 100 based on changes within presence datum 168, such as but not limited to changes in distance, changes in light intensity, changes in electromagnetic radiation and the like. In one or more embodiments, computing device 148 may compare presence datum 168 to one or more thresholds wherein exceeding and/or failing to meet the one or more thresholds may indicate that a user or an object is currently present and therefore eyewear device 100 is currently being worn by user. In one or more embodiments, even in a first mode, a user may not be wearing eyewear device 100 wherein any communication received may not be necessary. In one or more embodiments, computing device 148 may be configured to receive communication datum 164 as a function of presence datum 168 wherein computing device 148 may only receive communication datum 164 in instances where a user is wearing eyewear device 100. In one or more embodiments, communication datum 164 may be received only in instances wherein eyewear device 100 is in a first mode and presence datum indicated that a user is currently interacting with eyewear device. In one or more embodiments, presence datum 168 may further include any information received from one or more sensors on eyewear device 100 that may be used to make one or more determinations of whether a user is currently wearing eyewear device 100. This may include but is not limited to data received from one or more gyroscopic sensors, data received from one or more heart rate monitors, data received from one or more accelerometers and the like. In one or more embodiments, computing device 148 may receive presence datum 168 wherein computing device 148 may determine whether a user is currently present and/or wearing eyewear device 100. Computing device 148 may then receive communication datum 164 as a function of the presence datum 168. In one or more embodiments, receipt of presence datum 168 or the occurrence of an event may allow for an increase in computational efficiency. In one or more embodiments, data may be received only when it is used and not continuously. In one or more embodiments, eyewear device 100 may be powered with a battery wherein battery power may be preserved by limiting receipt of communication datum 164 to instances in which a user is present.

With continued reference to FIG. 1, computing device 148 may be configured to modify communication datum 164 and/or user speech. In one or more embodiments, computing device 148 may process audio data within communication datum 164 and/or user speech and convert audio data within communication datum 164 and/or user speech into textual data. In one or more embodiments, audio data may include audio signals. In one or more embodiments, computing device 148 may utilize an automatic speech recognition system which may include one or more speech to text systems wherein the system are configured to receive speech in the form of audio signals and/or audio data and convert the speech into textual data. “Automatic speech recognition” for the purposes of this disclosure is a system configured to convert speech into text. In some embodiments, automatic speech recognition may require training (i.e., enrollment). In some cases, training an automatic speech recognition model may require an individual speaker to read text or isolated vocabulary. In some cases, a solicitation video may include an audio component having audible verbal content, the contents of which are known a priori by computing device 148. Computing device 148 may then train an automatic speech recognition model according to training data which includes audible verbal content correlated to known content. In this way, computing device 148 may analyze a person's specific voice and train an automatic speech recognition model to the person's speech, resulting in increased accuracy. Alternatively or additionally, in some cases, computing device 148 may include an automatic speech recognition model that is speaker independent. As used in this disclosure, a “speaker independent” automatic speech recognition process does not require training for each individual speaker. Conversely, as used in this disclosure, automatic speech recognition processes that employ individual speaker specific training are “speaker dependent.”

Still referring to FIG. 1, in some embodiments, an automatic speech recognition process may perform voice recognition or speaker identification. As used in this disclosure, “voice recognition” refers to identifying a speaker, from audio content, rather than what the speaker is saying. In some cases, computing device 148 may first recognize a speaker of verbal audio content and then automatically recognize speech of the speaker, for example by way of a speaker dependent automatic speech recognition model or process. In some embodiments, an automatic speech recognition process can be used to authenticate or verify an identity of a speaker. In some cases, a speaker may or may not include subject. For example, subject may speak within solicitation video, but others may speak as well.

Still referring to FIG. 1, in some embodiments, an automatic speech recognition process may include one or all of acoustic modeling, language modeling, and statistically based speech recognition algorithms. In some cases, an automatic speech recognition process may employ hidden Markov models (HMMs). As discussed in greater detail below, language modeling such as that employed in natural language processing applications like document classification or statistical machine translation, may also be employed by an automatic speech recognition process.

Still referring to FIG. 1, an exemplary algorithm employed in automatic speech recognition may include or even be based upon hidden Markov models. Hidden Markov models (HMMs) may include statistical models that output a sequence of symbols or quantities. HMMs can be used in speech recognition because a speech signal can be viewed as a piecewise stationary signal or a short-time stationary signal. For example, over a short time scale (e.g., 10 milliseconds), speech can be approximated as a stationary process. Speech (i.e., audible verbal content) can be understood as a Markov model for many stochastic purposes.

Still referring to FIG. 1, in some embodiments HMMs can be trained automatically and may be relatively simple and computationally feasible to use. In an exemplary automatic speech recognition process, a hidden Markov model may output a sequence of n-dimensional real-valued vectors (with n being a small integer, such as 10), at a rate of about one vector every 10 milliseconds. Vectors may consist of cepstral coefficients. A cepstral coefficient requires using a spectral domain. Cepstral coefficients may be obtained by taking a Fourier transform of a short time window of speech yielding a spectrum, decorrelating the spectrum using a cosine transform, and taking first (i.e., most significant) coefficients. In some cases, an HMM may have in each state a statistical distribution that is a mixture of diagonal covariance Gaussians, yielding a likelihood for each observed vector. In some cases, each word, or phoneme, may have a different output distribution; an HMM for a sequence of words or phonemes may be made by concatenating an HMMs for separate words and phonemes.

Still referring to FIG. 1, in some embodiments, an automatic speech recognition process may use various combinations of a number of techniques in order to improve results. In some cases, a large-vocabulary automatic speech recognition process may include context dependency for phonemes. For example, in some cases, phonemes with different left and right context may have different realizations as HMM states. In some cases, an automatic speech recognition process may use cepstral normalization to normalize for different speakers and recording conditions. In some cases, an automatic speech recognition process may use vocal tract length normalization (VTLN) for male-female normalization and maximum likelihood linear regression (MLLR) for more general speaker adaptation. In some cases, an automatic speech recognition process may determine so-called delta and delta-delta coefficients to capture speech dynamics and might use heteroscedastic linear discriminant analysis (HLDA). In some cases, an automatic speech recognition process may use splicing and a linear discriminate analysis (LDA)-based projection, which may include heteroscedastic linear discriminant analysis or a global semi-tied covariance transform (also known as maximum likelihood linear transform [MLLT]). In some cases, an automatic speech recognition process may use discriminative training techniques, which may dispense with a purely statistical approach to HMM parameter estimation and instead optimize some classification-related measure of training data; examples may include maximum mutual information (MMI), minimum classification error (MCE), and minimum phone error (MPE).

Still referring to FIG. 1, in some embodiments, an automatic speech recognition process may be said to decode speech (i.e., audible verbal content). Decoding of speech may occur when an automatic speech recognition system is presented with a new utterance and must compute a most likely sentence. In some cases, speech decoding may include a Viterbi algorithm. A Viterbi algorithm may include a dynamic programming algorithm for obtaining a maximum a posteriori probability estimate of a most likely sequence of hidden states (i.e., Viterbi path) that results in a sequence of observed events. Viterbi algorithms may be employed in context of Markov information sources and hidden Markov models. A Viterbi algorithm may be used to find a best path, for example using a dynamically created combination hidden Markov model, having both acoustic and language model information, using a statically created combination hidden Markov model (e.g., finite state transducer [FST] approach).

Still referring to FIG. 1, in some embodiments, speech (i.e., audible verbal content) decoding may include considering a set of good candidates and not only a best candidate, when presented with a new utterance. In some cases, a better scoring function (i.e., re-scoring) may be used to rate each of a set of good candidates, allowing selection of a best candidate according to this refined score. In some cases, a set of candidates can be kept either as a list (i.e., N-best list approach) or as a subset of models (i.e., a lattice). In some cases, re-scoring may be performed by optimizing Bayes risk (or an approximation thereof). In some cases, re-scoring may include optimizing for sentence (including keywords) that minimizes an expectancy of a given loss function with regards to all possible transcriptions. For example, re-scoring may allow selection of a sentence that minimizes an average distance to other possible sentences weighed by their estimated probability. In some cases, an employed loss function may include Levenshtein distance, although different distance calculations may be performed, for instance for specific tasks. In some cases, a set of candidates may be pruned to maintain tractability.

Still referring to FIG. 1, in some embodiments, an automatic speech recognition process may employ dynamic time warping (DTW)-based approaches. Dynamic time warping may include algorithms for measuring similarity between two sequences, which may vary in time or speed. For instance, similarities in walking patterns would be detected, even if in one video the person was walking slowly and if in another he or she were walking more quickly, or even if there were accelerations and deceleration during the course of one observation. DTW has been applied to video, audio, and graphics—indeed, any data that can be turned into a linear representation can be analyzed with DTW. In some cases, DTW may be used by an automatic speech recognition process to cope with different speaking (i.e., audible verbal content) speeds. In some cases, DTW may allow computing device 148 140 to find an optimal match between two given sequences (e.g., time series) with certain restrictions. That is, in some cases, sequences can be “warped” non-linearly to match each other. In some cases, a DTW-based sequence alignment method may be used in context of hidden Markov models.

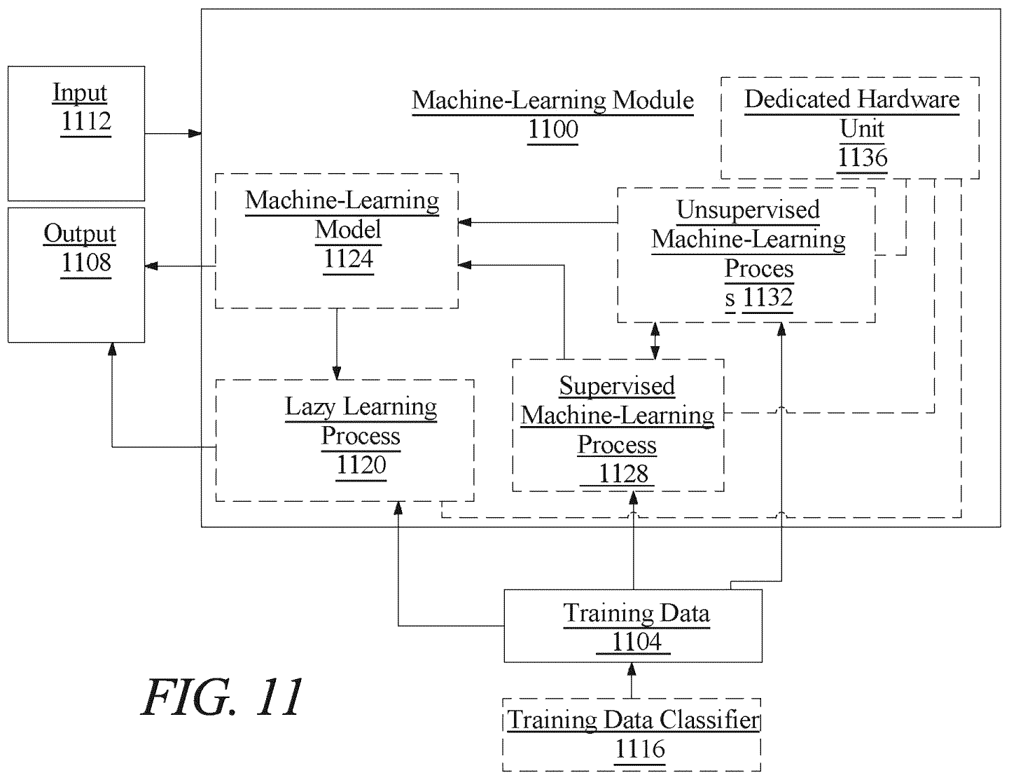

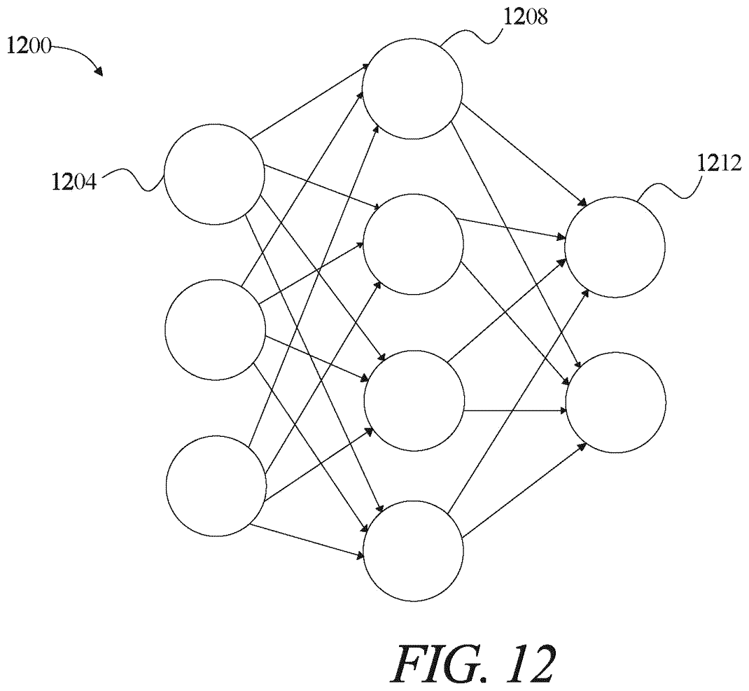

Still referring to FIG. 1, in some embodiments, an automatic speech recognition process may include a neural network. Neural network may include any neural network, for example those disclosed with reference to FIGS. 11-12. In some cases, neural networks may be used for automatic speech recognition, including phoneme classification, phoneme classification through multi-objective evolutionary algorithms, isolated word recognition, audiovisual speech recognition, audiovisual speaker recognition and speaker adaptation. In some cases, neural networks employed in automatic speech recognition may make fewer explicit assumptions about feature statistical properties than HMMs and therefore may have several qualities making them attractive recognition models for speech recognition. When used to estimate the probabilities of a speech feature segment, neural networks may allow discriminative training in a natural and efficient manner. In some cases, neural networks may be used to effectively classify audible verbal content over short-time interval, for instance such as individual phonemes and isolated words. In some embodiments, a neural network may be employed by automatic speech recognition processes for pre-processing, feature transformation and/or dimensionality reduction, for example prior to HMM-based recognition. In some embodiments, long short-term memory (LSTM) and related recurrent neural networks (RNNs) and Time Delay Neural Networks (TDNN's) may be used for automatic speech recognition, for example over longer time intervals for continuous speech recognition.

With continued reference to FIG. 1, automatic speech recognition may include the conversion of audio data of communication datum 164 and/or user speech into textual data. In one or more embodiments, textual data may include words, sentences and other speech that has been identified within communication datum 164 and/or user speech. In one or more embodiments, automatic speech recognition may identify speech within communication datum 164 and/or user speech and remove background noise. In one or more embodiments, automatic speech recognition may include techniques such as spectral subtraction wherein noise frequencies are isolated and removed. In one or more embodiments, computing device 148 may identify and distinguish speech from other unwanted background noises and remove said background noises. For example, and without limitation, unwanted background noises may include a car horn, traffic and the like wherein spectral subtraction techniques may be used to remove the unwanted background noises. In one or more embodiments, spectral subtraction may include isolating audio within communication datum 164 and/or user speech wherein the isolated audio contains only unwanted background noise. Then, a frequency of the background noise is determined and removed from the entire audio within communication datum 164 and/or user speech. In one or more computing device 148 may utilize high pass filters to remove low frequency noises such as humming sounds and such within audio signals. In one or more embodiments, computing device 148 may modify communication by removing unwanted background noises to allow for increased clarity of the speech within communication datum 164 and/or user speech. In one or more embodiments, computing device 148 may use automatic speech recognition to identify speech and distinguish the speech from unwanted background noise using one or more machine learning models. In one or more embodiments, the unwanted background noise may then be removed to allow for a datum having only speech contained within it.

With continued reference to FIG. 1, computing device 148 may be configured to generate modified communication datum 172 as a function of communication datum 164 and/or user speech. “Modified communication datum” for the purposes of this disclosure is a communication within communication datum 164 and/or user speech that has been modified to cater to the needs of a user. For example, and without limitation, modified communication datum 172 may include a computer-generated voice translation of a speech received within communication datum 164 and/or user speech. In one or more embodiments, communication datum 164 and/or user speech may include an audio containing speech wherein modified communication datum 172 may include information associated with the speech. In one or more embodiments modified communication datum 172 may include a communication within communication datum 164 and/or user speech wherein unwanted background noises are removed. In one or more embodiments, modified communication datum 172 may include a slowed down or sped up recording of the speech received within communication datum 164 and/or user speech. In one or more embodiments, modified communication datum 172 may include textual data of the speech within communication datum 164 and/or user speech wherein the speech has been converted into text. In one or more embodiments, modified communication datum 172 may include textual data in another language. In one or more embodiments, generating modified communication datum 172 may include converting communication datum 164 and/or user speech into a communication text 176 wherein the communication text 176 includes textual data of a communication or speech within communication datum 164 and/or user speech. In one or more embodiments, prior to modification and/or processing, speech within communication datum 164 and/or user speech may be converted into communication text 176 wherein the communication text 176 contains machine readable text of the communication within communication datum 164 and/or user speech. In one or more embodiments, computing device 148 may convert communication datum 164 and/or user speech into communication text 176. In one or more embodiments, computing device 164 may transmit communication text 176 to database 160. In one or more embodiments, database 160 may contain a computing device configured to generate modified communication datum 172 as a function of communication text and transmit modified communication datum 164 to computing device 148 and/or eyewear device 100. In one or more embodiments, modified communication datum 172 may be generated as function of communication text 176. In one or more embodiments, communication text 176 may include textual data of a speech within communication datum 164 and/or user speech wherein computing device 148 may translate communication text 176 into a desired language 184. In one or more embodiments, modified communication datum 172 may include communication text 176, a translation of communication text 176, a computer-generated voice reciting communication text 176 and the like. In an embodiment, computing device 148 may generate textual data and/or communication text 176 and convert the textual data to a specific language. In one or more embodiments, generating communication text 176 may include generated a translated communication text 180 as a function of communication text 176. In an embodiment, translated communication text 180 may include communication text 176 that has been translated to a particular language. For example, and without limitation, communication text 176 may include speech in Spanish, wherein translated communication text 180 may include the same speech in English. In one or more embodiments, computing device 148 may utilize one or more text to speech software to generate a computer-generated voice that will convert the textual data into a spoken language. In one or more embodiments, text to speech may be used to create a computer-generated voice of the textual data. In one or more embodiments, text to speech may allow for increased clarity on a speech spoken by an individual in communication with user. In one or more embodiments, text to speech may be used to generate speech in a differing language.

With continued reference to FIG. 1, modified communication datum 172 may include a communication in which surrounding noise has been removed. For example, and without limitation, communication datum 164 and/or user speech may include a speech by an individual wherein the communication datum 164 and/or user speech further includes background noises such as cars honking, dogs barking, wind blowing and the like. In one or more embodiments, eyewear device 100 may include a noise cancelling device configured to remove background noises. A “noise-cancelling device” for the purposes of this disclosure is a device configured to reduce background noise associated with a user. For example, noise-cancelling device may be used to mask background noises associated with traffic nearby, people talking near a user, and other sounds that may contribute to unwanted background noise. In some cases, noise-cancelling device may include a microphone configured to receive background noise associated with a user. In one or more embodiments, noise-cancelling device may reduce noises in already received communications such as communication datum 164 and/or user speech. In one or more embodiments, communication datum 164 and/or user speech may include environmental noise wherein the environmental noise includes background noise within communication datum 164 and/or user speech. In one or more embodiments, noise-cancelling device may be configured to receive an environmental signal associated with an environmental noise and/or communication datum and generate an inverted wavelength of the environmental noise to cancel out the resulting environmental noise. “Inverted wavelength” for the purposes of this disclosure is a noise wave having an inverted wavelength in comparison to the environmental noise signal. For example, in instance wherein environmental noise signal contains a high noise wave interview wavelength may contain a low noise wave. Noise-cancelling device may be communicatively connected to computing device 148, wherein computing device 148 may be configured to receive environmental signal and generate an inverted wavelength to be used to cancel out the environmental noise. Inverted wavelength may be generated by inverting environmental noise signal by multiplying environmental noise signal by −1. In some cases, noise-cancelling device may be configured to reduce background noise of a user, such that audio output device may generate outputs that only include communications. In some cases, audio output device 132 may be configured to generate noise cancelling waves wherein the noise cancelling waves may be configured to cancel out ambient noise for the user. In some cases audio output device 132 may generate multiple sound signals in sync such that ambient noise may be cancelled out while audio configured to neural stimulation is still provided. In one or more embodiments, eyewear device 100 may include noise cancelling device wherein noise cancelling device is configured to cancel out environmental noise surrounding the user. In one or more embodiments, noise cancelling device may cancel out surrounding noise of a user even in instances in which a communication is not being received. For example, and without limitation, eyewear device 100 may include noise cancelling device wherein a user may seek to cancel out ambient noises while wearing eyewear device 100. In one or more embodiments, audio input device may receive surrounding environmental noises wherein audio output device may be configured to produce inverted sounds which cancel out the environmental noise.

With continued reference to FIG. 1, computing device 148 may generate modified communication datum 172 as a function of user input 144. In one or more embodiments, computing device 148 may transmit communication datum 164, user speech, communication text 176, translated communication text 180 and the like to database 160, server network server and the like wherein a computing device located on database 160 may perform one or more processes and transmit the resulting modified communication datum to eyewear device 100. In one or more embodiments, one or more computing processes as described herein may be performed on eyewear device 100 and/or a remote computing device located on database 160 and/or a server. “User input” for the purposes of this disclosure an input made by a user to communication device to perform an action. For example, and without limitation, user input 144 may include the press of a button wherein the press of a button may signal to computing device 148 to perform an action. In one or more embodiments, user input 144 may be received through one or more user input devices 136 as described above. In one or more embodiments, user input 144 may include information as to how communication datum 164 may be modified. For example, and without limitation, user input 144 may include information indicating that communication datum 164 and/or user speech be translated, background noise within communication datum 164 and/or user speech should be removed, a volume associated with communication datum 164 should be increased and the like, a speech within communication datum 164 and/or user speech should be converted into text wherein a computer-generated voice may convert the speech into sounds and the like. In one or more embodiments, user input 144 may include an interaction with user input device 136 such as the push of a push button wherein each interaction may indicate a change in modes. For example, a first push may indicate a first mode, a second push may indicate a second mode and the like. In one or more embodiments, user input 144 may be received on a first iteration, wherein computing device 148 may store user input 144 on database for use in future iterations. For example, and without limitation, a user may input their own personal preferences as to how communication datum 164 should be modified wherein computing device 148 may modify communication datum 164 in each following iteration until a change is made. Continuing the example, a user may specify that communication datum 164 be translated into English wherein computing device 148 may detect a language for each communication datum 164 in each iteration and translate each communication datum 164 if or when it is necessary. In one or more embodiments, computing device 148 may modify communication datum 164 based on the user's specific needs. For example, and without limitation, a particular user may require communications to be translated to English whereas another user may require communication to be translated to Spanish. In one or more embodiments, user input 144 may further include information on the preferred playback speed of modified communication datum 172, the preferred volume, and/or any other preferences that will assist a user in understanding the communication received. In one or more embodiments, user input 144 may be dependent on how communication datum 164 was received. For example, and without limitation, a particular set of user inputs 144 may be associated with communication datum 164 associated with a phone call, whereas another set of user inputs 144 may be associated with communication datum 164 received from unidirectional audio input device located on eyewear frame 104. In one or more embodiments, user input 144 may further include a request to convert the communication or speech within communication datum 164 such that it is easier for the user to understand. For example, and without limitation, a user may indicate that words with a particular level of complexity should not be used wherein computing device 148 may replace complex words with easier words. Continuing the example, a communication in which an individual uses the word “ubiquitous” whereas modified communication datum 172 may use the word “everywhere”. In one or more embodiments, user input 144 may include a complexity level wherein the complexity level may indicate the complexity of the words within modified communication datum 172. For example, a low complexity level may indicate to computing device 148 to translate complex words or uses synonyms that aren't as complex within modified communication datum 172.

With continued reference to FIG. 1, user input 144 may include a desired language 184. “Desired language” for the purposes of this disclosure is a language in which the user prefers to hear the communication within communication datum 164. In an embodiment, desired language may be a language in which the user desires for user speech to be communicated to an individual. In one or more embodiments, communications within communication datum 164 having the same language as a desired language 184 may not require modification such that a computer-generated voice is needed to generate a translated communication. In one or more embodiments computing device 148 may determine a communication language 188 of communication datum 164 wherein the communication language 188 is the language that is being spoken within communication datum 164. In one or more embodiments, computing device 148 may use automated speech recognition to detect words or phrases within communication datum 164. Computing device 148 may then determine the language of the words or phrases to determine the communication language 188. In one or more embodiments, computing device 148 may transmit the words or phrases to a database in order to determine the language associated with the words or phrases. In one or more embodiments, computing device 148 may then compare the communication language 188 to the desired language 184. In instances in which the communication language 188 and the desired language 184 are the same, computing device 148 may not be required to translate communication datum 164. However, in instances in which communication language 188 and desired language 184 are different, then a translated communication text 180 may need to be generated. In one or more embodiments, computing device 148 may generate communication text 176 and generate translated communication text 180 as a function of communication text 176. In one or more embodiments, generating the translated communication text 180 as a function of the communication text 176 includes determining a communication language 188, comparing the communication language 188 to a desired language 184 and generating the translated communication text 180 as a function of the communication language 188 and the desired language 184. In one or more embodiments, translated communication text 180 may only be generated in instances in which communication language 188 and desired language 184 may not be the same. In one or more embodiments, an individual may speak a plurality of language within a single communication and/or use words emanating from other languages during a communication. In one or more embodiments, communication text 176 may contain more than one languages wherein translated communication text 180 may contain a singular language.

With continued reference to FIG. 1, communication datum 164 and/or user speech may be modified as a function of user input 144 wherein computing device 148 may generate modified communication datum 172 as a function of user input 144. In one or more embodiments, communication datum may be modified as a function of user input wherein computing device 148 may transmit communication 164 and/or communication text 180 to database 160 and receive modified communication datum 172. In one or more embodiments, computing device 148 may be configured to modify communication datum 164 as a function of a machine learning model. Computing device 148 may use a machine learning module, such as a communication machine learning module for the purposes of this disclosure, to implement one or more algorithms or generate one or more machine-learning models, such as a communication machine learning model 192, to create modified communication datum 172. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from database, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs 144 and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to categories by tags, tokens, or other data elements. A machine learning module, such as communication machine learning module, may be used to create communication machine learning model 192 and/or any other machine learning model using training data. Communication machine learning model 192 may be trained by correlated inputs and outputs of training data. Training data may be data sets that have already been converted from raw data whether manually, by machine, or any other method. Communication training data 196 may be stored in database. Communication training data 196 may also be retrieved from database. In some cases, communication machine learning model 192 may be trained iteratively using previous inputs correlated to previous outputs. For example, computing device 148 may be configured to store communication datum 164 of previous iterations and correlated modified communication datum 172s from a current iteration to train the machine learning model. In some cases, the machine learning model may be trained based on user input 144. For example, a user may indicate that one or more elements within modified communication datum 172 are inaccurate wherein the machine learning model may be trained as a function of the user input 144. In some cases, the machine learning model may allow for improvements to computing device 148 such as but not limited to improvements relating to comparing data items, the ability to sort efficiently, an increase in accuracy of analytical methods and the like.

With continued reference to FIG. 1, a machine learning model such as communication machine learning model 192 may be used to convert communication datum 164 into modified communication datum 172. In one or more embodiments, communication machine learning model 192 may be used to understand words, phrases sentences and such within an audio within communication datum 164 wherein communication machine learning model 192 may convert the audio into machine readable text. In one or more embodiments generating modification communication datum 164 may include receiving communication training data 196 having a plurality of communication data correlated to a plurality of modified communication data. In an embodiments, an element of communication datum 164 may be correlated to an output element of modified communication datum 172. In an embodiments, a portion of an audio signal may be correlated to a particular word or text. In one or more embodiments, communication training data 196 may be created by a user, a third party and the like. In one or more embodiments, communication training data 196 may include communication datum 164 of previous iterations and correlated modified communication datum 172. In one or more embodiments, modified communication datum 172 may be generated as a function of communication machine learning model 192. In one or more embodiments, communication machine learning model 192 may be trained iteratively wherein a user may indicate whether outputs of communication machine learning model 192 are accurate. For example, and without limitation, communication machine learning model 192 may incorrectly convert a spoken word into textual data wherein a user may indicate that the textual data is inaccurate and provide the correct word or phrase. In one or more embodiments, communication machine learning model 192 may be trained by each user specifically trains communication machine learning model 192. In one or more embodiments, the individuals that a user may interact with may contain various dialects and such that requiring training of one or more machine learning models in order to produce accurate outputs.

With continued reference to FIG. 1, communications or speech within communication datum 164 may be partial or somewhat incoherent due to missing words, incorrectly used phrases and the like. In one or more embodiments, computing device 148 may utilize an inference engine to deduce any missing words or phrases within communication datum 164 and/or modified communication datum 172. For example, and without limitation a communication within communication may be translated to text as “I store” wherein inference engine may be used to deduce that the individual was communication that they went to the store. As a result, modified communication datum 172 may include text or speech stating, “I went to the store.”. “Inference engine” for the purposes of this disclosure is system which applies a set of logical rules to in order to deduce new knowledge. In one or more embodiments, inference engine may be used to draw logical conclusions between two words, phrases and the like. In one or more embodiments, inference engine may be used to generate a transition between two words or phrases in order to create grammatically correct phrases or sentences. In one or more embodiments, inference engine may be used to ensure that inconsistencies within a translated text or phrase may not arise.

With continued reference to FIG. 1, inference engine may include and/or be communicatively connected to a knowledge base. “Knowledge base” for the purposes of this disclosure is a collection of information that is used by inference engine to generate logical inferences and conclusions. In one or more embodiments, knowledge base may include a plurality of words, phrases and various grammatical rules or relationships. In one or more embodiments, the inference engine may apply logical rules to the knowledge base in order to generate new knowledge. In one or more embodiments, inference engine may contain a plurality of logical rules that have been retrieved from database. In one or more embodiments, inference engine may be used to generate logical inferences between words, phrases, sentences and the like within communication datum 164 and/or modified communication datum 172. In one or more embodiments, a machine learning model containing logical training data may be used to generating logical rules for the inference engine. In one or more embodiments, logical training data may include a plurality of words correlated to a plurality of logical rules. In one or more embodiments, communication datum 164 and/or communication text 176 may be fed into machine learning model to receive one or more logical rules to be used for interference engine. In one or more embodiments, database may be populated with a plurality of logical rules that may be used to generate inferences between two or more words to generate grammatically correct and coherent sentences.

With continued reference to FIG. 1, in one or more embodiments, computing device 148 may utilize a large language model to convert communication text 176, modified communication datum 172 and/or translated communication text 180 into coherent sentences and/or phrases. In one or more embodiments, large language model may be located on database wherein computing device 148 may transmit communication 176 to database 160 and receive modified communication datum 172. In one or more embodiments, based on user input 144, computing device 148 may change the complexity of words within communication text 176 and/or translated communication text 180 to create sentences that may be more understandable to user. In one or more embodiments, the large language model may be configured to translate a communication within communication datum. For example, and without limitation, the large language model may receive communication text 180, wherein the large language model may translate the communication and generate modified communication datum 172. In one or more embodiments, modified communication datum 172 may contain a translated communication wherein the large language model has translated the communication from communication text 180. In one or more embodiments, user input 144 may include information indicating that communications should be simplified wherein the user only seeks to understand the crux of the speech rather than the entire speech itself. In one or more embodiments, communication text 176 and/or translated communication text 180 may be fed into a large language model wherein the large language model may output modified communication datum 172 based on user input 144. In one or more embodiments, outputs of the large language model may include communications that have been modified based on user input 144. This may include communications containing simplified words, communications that have been made coherent following a translation and the like. In one or more embodiments, generating modified communication datum 172 may include training and/or utilizing a large language model (LLM). In one or more embodiments, communication text 176 and/or translated communication text 180 may be input into the large language model in order to receive modified communication datum 172. A “large language model,” as used herein, is a deep learning algorithm that can recognize, summarize, translate, predict and/or generate text and other content based on knowledge gained from massive datasets. LLMs may be trained on large sets of data; for example, training sets may include greater than 1 million words. Training sets may be drawn from diverse sets of data such as, as non-limiting examples, novels, self-help books, autobiographies, biographies, blog posts, articles, emails, and the like. Training sets may include a variety of subject matters, such as, as nonlimiting examples, medical tests, novels, autobiographies, romantic ballads, beat poetry, emails, advertising documents, newspaper articles, and the like. LLMs, in some embodiments, may include GPT, GPT-2, GPT-3, and other language processing models. LLM may be used to augment the text in communication text 176 and/or translated communication text 180 based on a prompt. Training data may correlate communication text 176 and/or translated communication text 180 to plurality of prompts. A “prompt,” as used herein, is a topic of focus in generating modified communication datum 172. The prompt may be any instruction to the neural network relating to the desired content or format of modified communication datum 172. For example, prompt may indicate a desired complexity of words, a desire to create coherent sentences, a desire to shorten the communication and the like. Training data may correlate elements of a dictionary related to linguistics, as described above, to a prompt. LLM may include a text prediction-based algorithm configured to receive an article and apply a probability distribution to the words already typed in a sentence to work out the most likely word to come next with modified communication datum 172. For example, if the words already typed are “Nice to meet”, then it is highly likely that the word “you” will come next. LLM may output such predictions by ranking words by likelihood or a prompt parameter. For the example given above, the LLM may score “you” as the most likely, “your” as the next most likely, “his” or “her” next, and the like.

Still referring to FIG. 1, LLM may include an attention mechanism, utilizing a transformer as described further below. An “attention mechanism,” as used herein, is a part of a neural architecture that enables a system to dynamically highlight relevant features of communication text 176 and/or translated communication text 180.=. In natural language processing this may be a sequence of textual elements. It may be applied directly to the raw input or to its higher-level representation. An attention mechanism may be an improvement to the limitation of the Encoder-Decoder model which encodes the input sequence to one fixed length vector from which to decode the output at each time step. This issue may be seen as a problem when decoding long sequences because it may make it difficult for the neural network to cope with long sentences, such as those that are longer than the sentences in the training corpus. Applying an attention mechanism, LLM may predict the next word by searching for a set of position in a source sentence where the most relevant information is concentrated. LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation. In some embodiments, LLM may include encoder-decoder model incorporating an attention mechanism.

Still referring to FIG. 1, LLM may include a transformer architecture. In some embodiments, encoder component of LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 1, LLM and/or transformer architecture may include an attention mechanism. An “attention mechanism,” as used herein, is a part of a neural architecture that enables a system to dynamically quantify the relevant features of input data such as communication text 176 and/or translated communication text 180. In the case of natural language processing, input data may be a sequence of textual elements. It may be applied directly to the raw input or to its higher-level representation.

With continued reference to FIG. 1., an attention mechanism may represent an improvement over a limitation of the Encoder-Decoder model. The encoder-decider model encodes the input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, LLM may predict the next word by searching for a set of position in a source sentence where the most relevant information is concentrated. LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 1., an attention mechanism may include generalized attention self-attention, multi-head attention, additive attention, global attention, and the like. In generalized attention, when a sequence of words or an image is fed to LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, LLM may pick up particular parts at different positions in the input sequence and over time compute an initial composition of the output sequence. In multi-head attention, LLM may include a transformer model of an attention mechanism. Attention mechanisms, as described above, may provide context for any position in the input sequence. For example, if the input data is a natural language sentence, the transformer does not have to process one word at a time. In multi-head attention, computations by LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), LLM may make use of attention alignment scores based on a number of factors. These alignment scores may be calculated at different points in a neural network. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, LLM may either attend to all source words or predict the target sentence, thereby attending to a smaller subset of words.

With continued reference to FIG. 1., multi-headed attention in encoder may apply a specific attention mechanism called self-attention. Self-attention allows the models to associate each word in the input, to other words. So, as a non-limiting example, the LLM may learn to associate the word “you”, with “how” and “are”. It's also possible that LLM learns that words structured in this pattern are typically a question and to respond appropriately. In some embodiments, to achieve self-attention, input may be fed into three distinct fully connected layers to create query, key, and value vectors. The query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

With continued reference to FIG. 1., in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 1, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

With continued reference to FIG. 1., transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With continued reference to FIG. 1., in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 1., first multi-headed attention layer may be configured to not condition to future tokens. As a non-limiting example, when computing attention scores on the word “am”, decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves “zero” attention scores for “future tokens.”

With continued reference to FIG. 1., second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 1., the output of the pointwise feedforward layer may be fed through a final linear layer. This final linear layer may act as a classifier. This classifier may be as big as the number of classes that you have. For example, if you have 10,000 classes for 10,000 words, the output of that class will be of size 10,000. The output of this classifier may be fed into a softmax layer which may serve to produce probability scores between zero and one. The index may be taken of the highest probability score in order to determine a predicted word.

With continued reference to FIG. 1., decoder may take this output and add it to the decoder inputs. Decoder may continue decoding until a token is predicted. Decoder may stop decoding once it predicts an end token.

With continued reference to FIG. 1., in some embodiment, decoder may be stacked N layers high, with each layer taking in inputs from the encoder and layers before it. Stacking layers may allow LLM to learn to extract and focus on different combinations of attention from its attention heads.

With continued reference to FIG. 1, LLM may convert communication text 176 and/or translated communication text 180 into a coherent communication wherein modified communication datum 172 may include the textual data and/or a computer-generated voice of the textual data. In one or more embodiments, in instances where a user may seek to only enhance the audibility of a communication modified communication datum 172 may include communication datum 164 that is played at a higher volume. In one or more embodiments, modified communication may include solely the voice of the individual in communication with user without any background noises. In one or more embodiments, eyewear device 100 may allow for sounds only within the sight of the user to be picked up. In contrast with other hearing aids, eyewear device 100 may allow a user to focus on a particular area in which sounds may be amplified based on the orientation of the user's head.

With continued reference to FIG. 1, computing device 148 is configured to transmit modified communication data to audio output device 132. In one or more embodiments, in instances in which modified communication datum 172 may include textual data, computing device 148 may convert textual data into audible sounds. In one or more embodiments, computing device 148 may utilize one or more text to speech systems wherein a text is fed into a system and a computer-generated audio of the text is output. In one or more embodiments, modified communication datum 172 may be transmitted to audio output device 132. In one or more embodiments, in instances in which an audio output device 132 may be situated on each temple 116 of eyewear frame 104, computing device 148 may be configured to transmit modified communication datum 172 to each audio output device 132. In one or more embodiments, transmission of modified communication datum 172 to audio output device 132 may be dependent on user input 144. In one or more embodiments, a user may indicate whether modified communication datum 172 should be transmitted to a particular audio output device 132 or both audio output devices 132. In one or more embodiments, transmission of modified communication datum 172 may be dependent on the source of communication datum 164. For example, and without limitation, in instances where communication datum 164 is received from an ongoing phone call, modified communication datum 172 may be transmitted to one audio output device 132 in order to simulate a phone call, whereas in instances in which user is communicating with an individual, modified communications datum may be transmitted to both audio output devices 132.

With continued reference to FIG. 1, in one or more embodiments, computing device 148 may receive posture data from sensor suite 120. “Posture data” data for the purposes of this disclosure is information associated with the posture of a user. Posture data may include information indicating the user's head relative to the ground or another reference point. In one or more embodiments, posture data may be used to determine instances in which a user's head is situated downward and/or in a direction which may affect the posture of the user. In one or more embodiments, posture data may include orientation angles in which the orientation angles may indicate the orientation angle of eyewear device 100 and ultimately the positioning of a user's head. In one or more embodiments, posture data may only be received in instances in which presence datum 168 indicates that the user is currently wearing eyewear device 100. In one or more embodiments, posture data may be inaccurate in instances in which eyewear device 100 is set down on a table, tucked away and/or held in a user's hand. In one or more embodiments, posture data may be received in instances only when the user is currently wearing eyewear device 100. In one or more embodiments, posture data may be compared to one or more thresholds wherein exceeding of the one or more thresholds may indicate that the current posture of a user is unsatisfactory and/or unhealthy. In one or more embodiments, posture data may be time dependent. In one or more embodiments, a user may orient their head downward and/or upward at varying times, such as when looking at their phone, a book and the like. in one or more embodiments, posture data may include a range of orientation angles over a given times frame wherein exceeding the time frame may indicate that the user has an unsatisfactory posture. In one or more embodiments, computing device 148 may compare posture data to one or more thresholds wherein exceeding the threshold may indicate that an unsatisfactory head orientation has been present for a particular time. In one or more embodiments, eyewear device 100 may include one or more vibration motors and/or actuators which are configured to vibrate eyewear device 100 to alert user that their orientation is unsatisfactory. In one or more embodiments, computing device 148 may alert a user either through an audio alert or through a vibration of eyewear device 100 wherein a user may be put on notice that their posture needs to be fixed. In one or more embodiments, eyewear device 100 may allow a user to continuously trained to fix their posture by providing alerts in order to notify a user when their posture is unsatisfactory. In one or more embodiments, the one or more thresholds used to determine posture may be received from a database, user third party and the like.

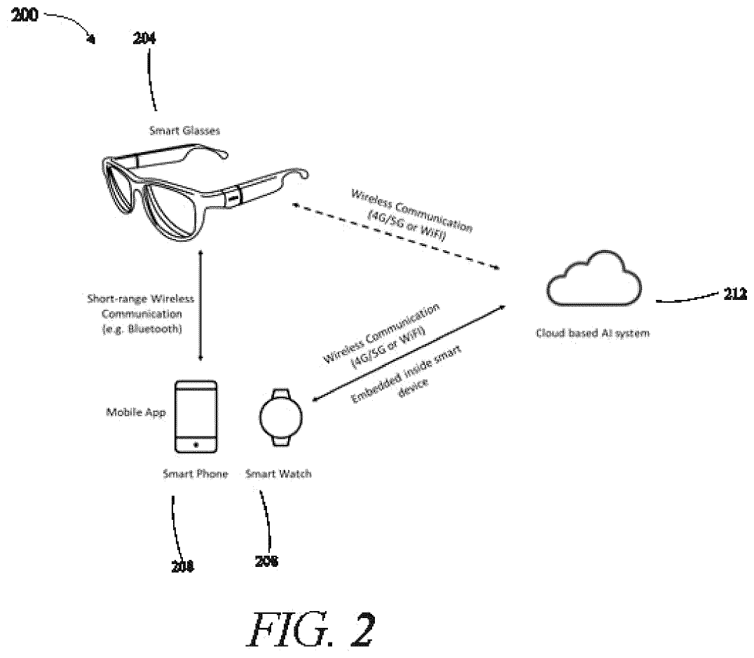

With continued reference to FIG. 1, eyewear device 100 may allow for receipt of audio from remote device 140, such as audio including but not limited to, phone calls, music, podcasts and/or any other audio. In one or more embodiments, audio may be transmitted to audio output device 132. In one or more embodiments, audio received from audio input device may be amplified by audio output device 132 wherein the user may receive amplified sound. In one or more embodiments, audio received from audio input device may be translated and/or converted into a computer-generated voice. In one or more embodiments, a communication received from eyewear device 100 may be modified to provide clarity in speech. In one or more embodiments, modes on eyewear device 100 may allow for differing uses of eyewear device 100. For example, and without limitation, first mode may be used for physical communications wherein an individual may be physically present in front of user. In first mode, an individual may communicate with a user wherein the communication may be received from first audio input device 164 as communication datum and output out of audio output device as modified communication datum 172. In another non limiting example, in second mode, eyewear device may be used for communication through remote device 140, such as a phone call, wherein user speech may be received from second audio input device 130 and transmitted to remote device 140. In one or more embodiments, communications form remote device 140 may be transmitted to audio output device 132. In one or more embodiments, in second mode, eyewear device may be used similarly to a telephonic device wherein communications may be received and transmitted. In one or more embodiments, first mode may be referred to as a “hearing mode” wherein the hearing mode is configured to assist a user in receiving communications from individuals physically present in front of user. In one or more embodiments, second mode may be referred as a “phone mode” wherein eyewear device 100 may act similarly to a telephonic device. In one or more embodiments, eyewear device 100 may include an eyewear device 100, such as an open-ear hearing assist smart glasses system as described in this disclosure such as in reference to FIGS. 2-10.

With continued reference to FIG. 1, in one or more embodiments, computing device 148 may be configured to perform one or more actions based on the pressing of a button or an input made through user input device 136. In one or more embodiments, buttons, switches, and the like on eyewear frame 104 may contain preconfigured instructions. In one or more embodiments, the preconfigured instructions may include instructions configuring computing device 148 to receive audio from audio input device, second audio input device 130 and the like. In one or more embodiments, selection of a button on eyewear frame 104 may indicate to computing device 148 that communication datum 164 should be received from audio input device and transmitted to audio output device 132. In one or more embodiments, selection of a push button may further indicate to computing device 148 to receive a communication from second audio input device 130 wherein communications from second audio input device 130 may be transmitted to remote device 140. In one or more embodiments, selection of push buttons may indicate to computing device 148 to execute one or more sets of instructions. In one or more embodiments, in a first set of instructions, computing device 148 may receive communication datum 164 from audio input device located physically on eyewear frame 104 wherein communication datum 164 includes communications made by an individual in the physical presence of user. In one or more embodiments, first set of instructions may be used to clarify communications made in the physical presence of a user. In one or more embodiments, first set of instructions may be used to aid users who don't speak a particular language and/or aid users with hearing disabilities. In one or more embodiments, in a second set of instructions, computing device 148 may receive communication datum 164 from remote device 140 and transmit the communication datum 164 to eyewear device 100. In one or more embodiments, computing device 148 may be configured to receive an audio from second audio input device 130 wherein the audio includes communications made by a user. In one or more embodiments, second set of instructions may be used to simulate a phone call, wherein eyewear device 100 may be used to second and receive communications within the phone call.

It is to be noted that one or more processes performed on computing device 148 may be performed on a cloud server, network server, server database, and the like. In one or more embodiments, computing device 148 may receive generate communication text 172, transmit the communication text 176 to a cloud network, server, database 160 and the like and receive modified communications datum 172. In one or more embodiments, eyewear device 100 may be communicatively connected to a database, cloud network and/or server either directly or through remote device 140. As used in this disclosure, “directly” is communication between computing device 148 and cloud server, network server, server database, and the like independent from a remote device, such as remote device 140. In one or more embodiments, processes may be performed on a cloud server, server, and/or database wherein computing power may be preserved on eyewear device. In one or more embodiments, processes such as generation of translated communication text and/or generation of modified communication datum may occur on server and transmitted back to eyewear device 100. In one or more embodiments, transmission of data to a cloud server, server and/or database may reduce power consumption of eyewear device 100. In one or more embodiments, eyewear device may be battery powered wherein a decrease in computational usage may allow for increased battery life of eyewear device 100. In one or more embodiments, processes such as modification of communication text 176, generation of translated communication text 180, generation of modified communication datum 188 and the like may be performed by a cloud network, server, network server, and/or database and transmitted to eyewear device 100.

Referring now to FIG. 2, system block diagram 200, according to embodiments of the invention is described. With reference to FIG. 2, in various embodiments, an open-ear hearing assist smart glasses system 200, includes the following components, an open-ear smart glasses body 204, a Mobile terminal such as a mobile phone 208 or a Smart Watch (with one or more Application programs), and a Cloud based Artificial Intelligence (AI) system 212.

In various embodiments, the open-ear smart glasses body 204 can operate individually as a hearing assist device. These three components are also connected via wireless communication to provide advanced features for hearing assist or real-time language translation.

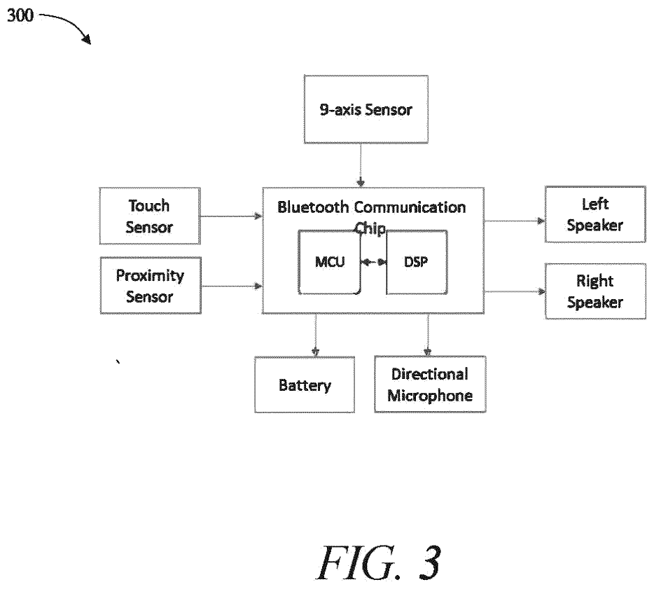

FIG. 3 is an exemplary system 300 illustrating hardware components, according to embodiments of the invention. With reference to FIG. 3, the hearing assist smart glasses hardware components are illustrated in various embodiments. The Bluetooth communication chip consists of a microcontroller unit (MCU) and digital signal processing (DSP) cores. In various embodiments, the MCU is mainly used for user interface (UI), task operation, and real-time operating system (OS) operations. The DSP cores are typically focused on time-consuming signal processing algorithms and Bluetooth wireless communication algorithms.

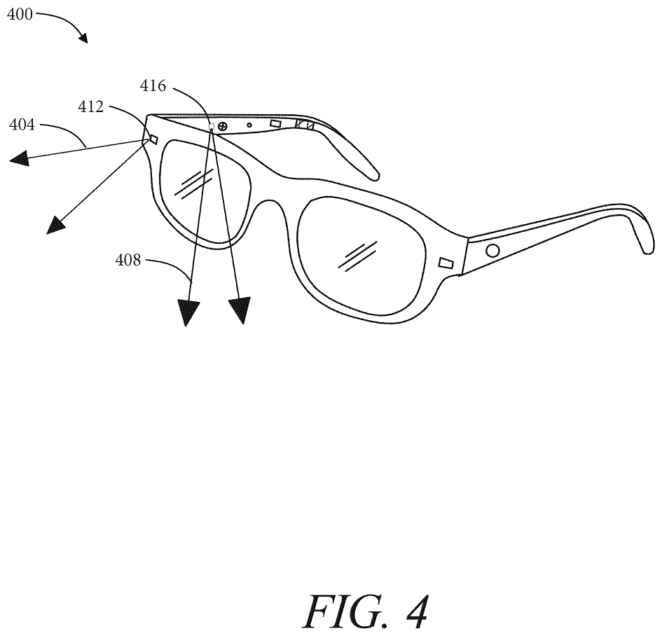

FIG. 4 illustrates an exemplary eyewear device 400 and corresponding audio beam directions, according to embodiments of the invention. With reference to FIG. 4, a non-limiting example of audio beam directions for “Phone” and “Hearing” modes (directional microphone on RIGHT temple) are illustrated. In one or more embodiments, in a hearing mode, hearing beam 404, may be directed in front of a field of view of user. In one or more embodiments, hearing beam 404 may be used to receive communication from an individual communicating with user. In one or more embodiments, a listening beam 408 may be directed to user and configured to receive communication from a user. In one or more embodiments, listening beam may only be configured to receive audio in a “phone” mode wherein audio may be received from eyewear device and transmitted to an individual. In one or more embodiments, hearing beam 404 may be generated by audio input device wherein audio input device 412 may receive a communication from an individual physically present in front of user. In one or more embodiments, listening beam 408 may be generated by second audio input device 130 416 wherein second audio input device 130 416 is configured to receive a communication from user. In one or more embodiments, a switch between hearing mode and phone mode may be made through the selection of a button on eyewear device. In one or more embodiments, FIG. 4 illustrates additional audio beam directions, according to embodiments of the invention. As a non-limiting example of audio beam directions for “Phone” and “Hearing” Modes (directional microphone (and/or unidirectional audio input device) on LEFT temple) are illustrated. In one or more embodiments, in a “Phone” mode, audio may be received from a remote device, wherein the audio includes audio associated with a phone call. In one or more embodiments, in a phone mode, audio received by eyewear device may be associated with communications associated with user while in a hearing mode, audio received by eyewear device 400 may be associated with an individual physically present in front of user. In one or more embodiments, in a phone mode, audio may be transmitted to a singular audio output device in order to simulate a phone call. In one or more embodiments, in a “Hearing” mode, audio may be received from an audio input device such as an audio input device as described above. In one or more embodiments, in a hearing mode, audio may be output to one or more audio output device such as each audio output devices located on each temple as described in reference to FIG. 1.

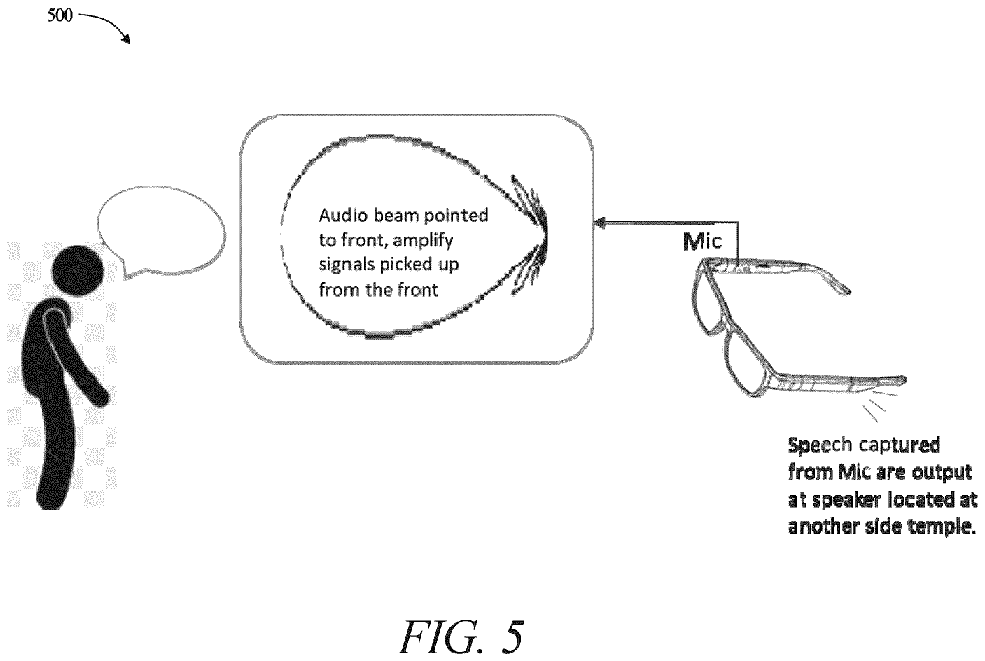

Referring now to FIG. 5, an exemplary system 500 illustrating a hearing mode according to embodiments of the invention is described. “Hearing mode” for the purposes of this disclosure is a set of rules or instructions in which a computing device is configured to receive a communication from an individual physically present in front of a user, from one or more audio output devices located on eyewear device. For example, and without limitation, in a hearing mode, a computing device may be configured to receive audio from an audio input device directed within a field of view of a user. In a hearing mode, eyewear device may receive surrounding sounds and transmit those sounds to an audio output device located on eyewear device. “Phone mode” of the purposes of this disclosure is a set of rules or instructions in which a computing device is configured to receive an audio from the user from one or more audio output devices located on eyewear device. In a phone mode, computing device is configured to receive a communication from a user whereas in a hearing mode, computing device is configured to receive a communication physically present in front of user. In one or more embodiments, in a phone mode, communications made by an individual are received by a device communicatively connected to a remote device such as a smart phone. In one or more embodiments, in a phone mode, communications made by a user are received by eyewear device and transmitted to remote device. In one or more embodiments, in a hearing mode, communications are received from one or more audio input devices on eyewear device, whereas communications from a user are not received. In one or more embodiments, a sound and/or communication may be received from an individual using a unidirectional audio input device. In one or more embodiments, communications and/or speech may focus on the individual to allow for increased clarity of a communication. In one or more embodiments, speech and/or communication may be output through audio output device. In one or more embodiments, audio output device may be located on each template of eyewear frame. In one or more embodiments, unidirectional audio input device may be located on an inner surface of temple. In one or more embodiments, unidirectional audio input device may be located on frame front. In one or more embodiments, unidirectional audio input device may be configured to capture sounds with a field of view of user. In one or more embodiments, in an audio beam mode, audio is captured from the physical surroundings of user using an audio input device located on a remote device. In one or more embodiments, in a hearing mode, audio may be transmitted to two audio output devices wherein an audio output devices may be located on each temple of eyewear frame. In a hearing mode, audio may be transmitted to both ears of a user.

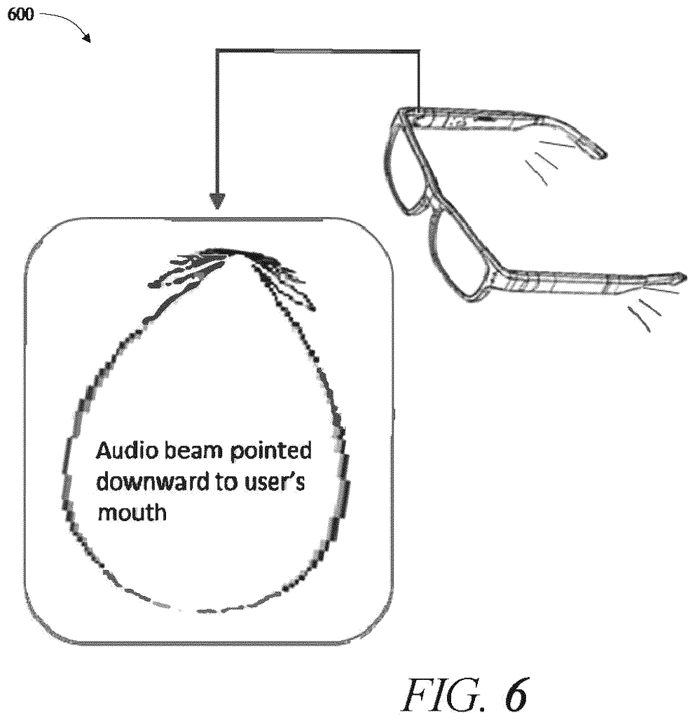

With reference to FIG. 6, an exemplary system 600 illustrating a phone mode according to embodiments of the invention is described. In one or more embodiments, eyewear device may include a second audio input device 130 wherein the second audio input device 130 is configured to receive a communication made by user. In one or more embodiments, audio input device may include a unidirectional audio input device wherein the unidirectional audio input device is located on temple of eyewear device. In one or more embodiments, in a “phone” mode, a user may utilize eyewear device to make and receive phone calls. In one or more embodiments, audio input device may receive communications made by user wherein the communications may be transmitted to an individual in communication with user. In one or more embodiments, eyewear device may further include audio output devices wherein the audio output devices are configured to transmit audio received from the individual in telephonic communication with the user.

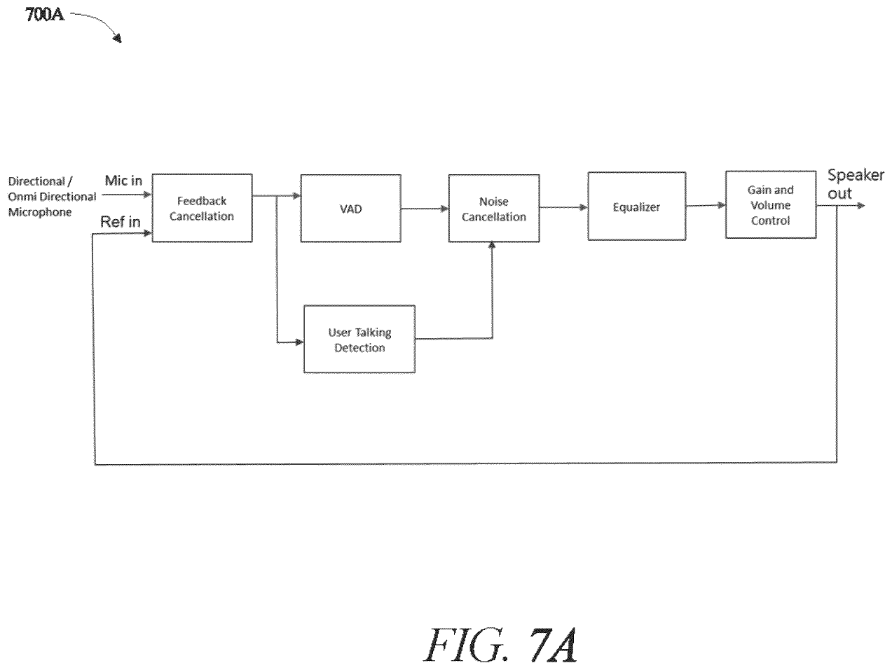

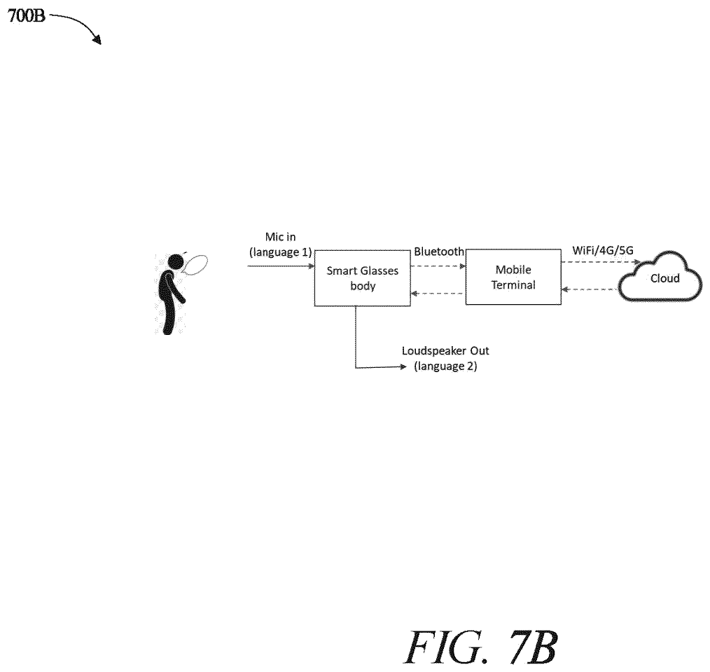

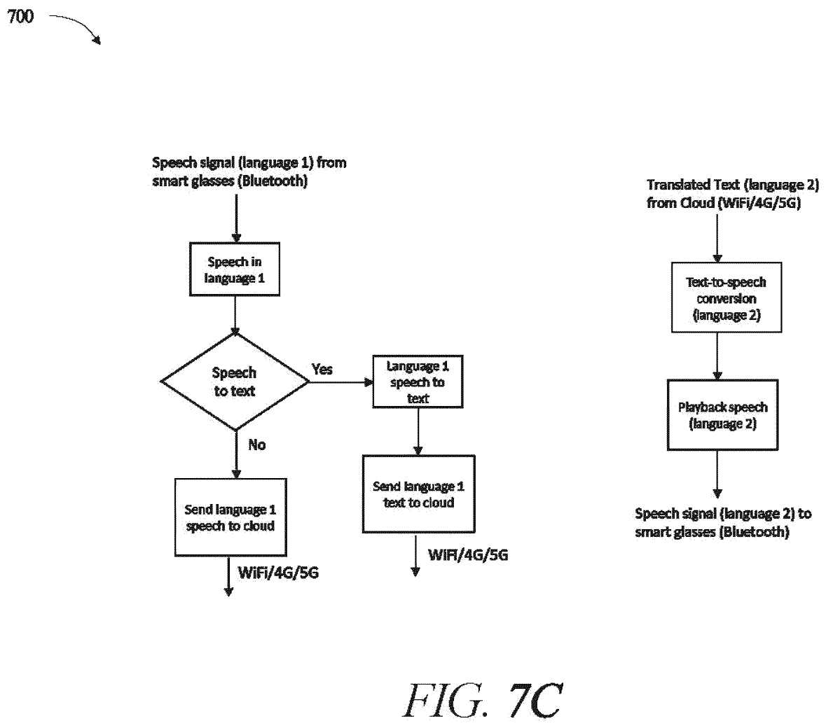

Referring now to FIG. 7A, an exemplary embodiment of a signal processing algorithm 700 for “Hearing” mode, according to embodiments of the invention, is described. With reference to FIG. 7A, a non-limiting example of Signal processing algorithms 700A under “Hearing” mode to provide hearing loss assistance is illustrated. FIG. 7B illustrates processing flow 700B for “Hearing” mode, according to embodiments of the invention. With reference to FIG. 7B, a non-limiting example of processing flow 700B under “Hearing” mode in real-time speech translation is illustrated. FIG. 7C illustrates mobile terminal real-time speech translation, according to embodiments of the invention. In one or more embodiments, in a hearing mode, or a first mode, audio may be received from eyewear device and transmitted to a remote device and/or cloud network for processing. In one or more embodiments, processing for communication datum may take place on a cloud network and/or database wherein an eyewear device, such as in reference to FIG. 1, may transmit communication datum to a cloud network and receive modified communication datum. In one or more embodiments, one or more processes may occur on a cloud network. In one or more embodiments, one or more processes may occur on a computing device communicatively connected to eyewear device 100. In one or more embodiments, a directional microphone is used to pick up speech signals and then send then signals to MCU/DSP and/or a cloud network for speech processing such as in reference to FIG. 7A. In various embodiments, different combinations of sensors are provided in the smart glasses, such as a 9-axis sensor package. For example, a 9-axis sensor package captures 9-axes of sensor data (3-axis accelerometer, 3 axis gyroscopes, 3-axis magnetometer) and passes these data to a mobile terminal. These data are used for example for posture monitoring of a user. Examples of other sensors that are incorporated into the smart glasses are, but are not limited to, touch sensors, utilized for loudspeakers volume control; proximity sensors utilized for the music play functionality such as “play” or “pause” music and control of power (on/off). In various embodiments, a left-side loudspeaker is incorporated into the glasses and is used to broadcast speech to a user and for music output. In one or more embodiments, one or more noise cancelling algorithms may be used using one or more noise cancelling devices as described in this disclosure. In one or more embodiments, the noise cancelling algorithm may produce inverted soundwaves to cancel out background sounds picked up from eyewear device 100. In one or more embodiments, proximity sensors may further be used for noise cancelling wherein a user may indicate whether they would prefer for a noise cancelling functionality to be active. In various embodiments, a right-side loudspeaker is incorporated into the glasses and is used to broadcast speech to a user and for music output. In various embodiments, one or more batteries are used to supply voltage to hardware components. In one or more embodiments, one or more batteries may be located within eyewear frame. In one or more embodiments, the one or more batteries may be rechargeable wherein eyewear device may be continuously recharged.

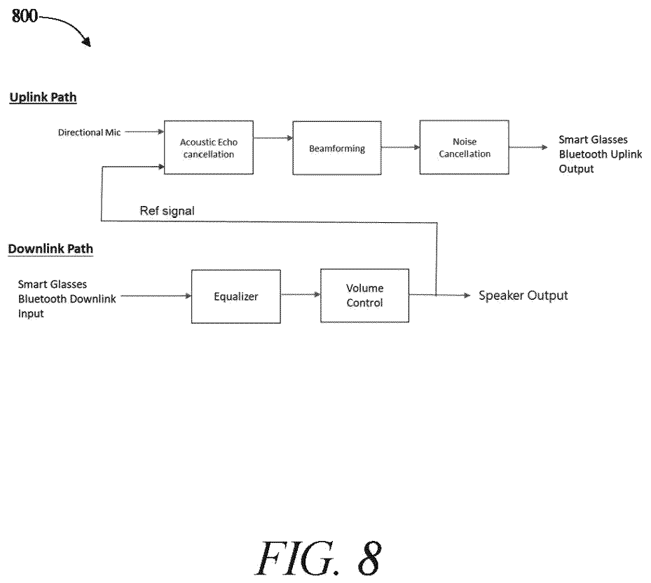

Referring now to FIG. 8, an exemplary embodiment of a signal processing algorithm 800 for “Phone” mode, according to embodiments of the invention is described. In one or more embodiments, in a phone mode, communications made by a user made be received by a directional and/or unidirectional audio input device such as a microphone and/or second unidirectional audio input device as described in reference to FIG. 1. In one or more embodiments communications made by a user may be received eyewear device and transmitted to remove device. In one or more embodiments, in a phone mode, communications made by an individual may be received by remote device and transmitted to one or more audio output devices on eyewear device. In one or more embodiments, one or more noise cancelling algorithm and/or noise cancelling devices may be used to reduce background noises that have been received by a microphone. In one or more embodiments, a communication that has been received by eyewear device 100 such as user speech may be modified such that background noises may be removed using acoustic noise cancellation (ANC). In one or more embodiments, ANC may cancel out undesired noises by generating inverted sound signals. In one or more embodiments, in a second mode and/or phone mode, undesired sounds within user speech may be cancelled out using ANC wherein only desired sounds may be transmitted. In one or more embodiments, noise cancelling device may further provide for active noise cancellation wherein noise of a surrounding area may be reduced. In one or more embodiments, audio output device 132 may emit inverted sound signals to reduce unwanted noise. In one or more embodiments, an audio input device may receive sounds, wherein noise cancelling device may generate inverted signals and emit the inverted signals through audio output device.

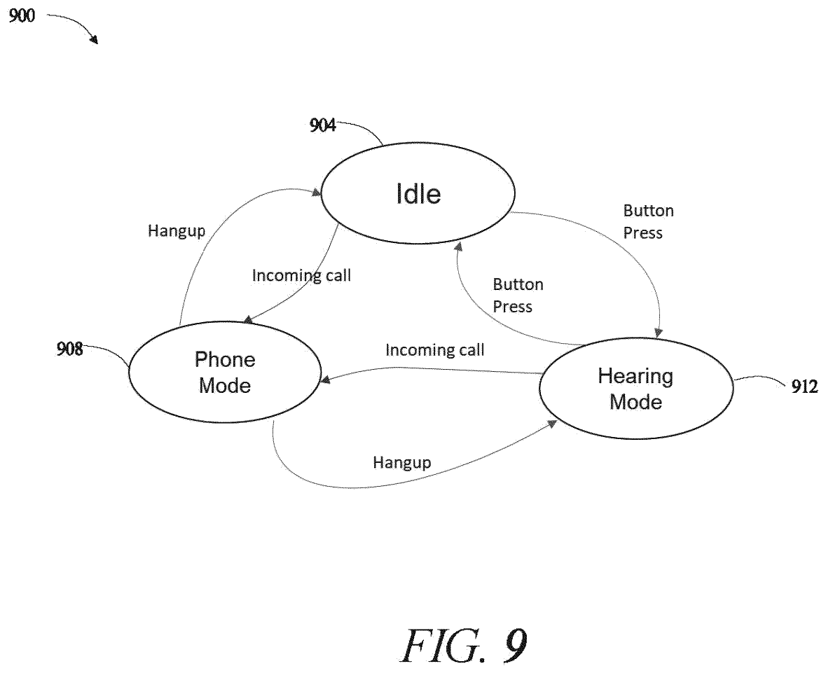

Referring now to FIG. 9, An exemplary embodiments, of a logic system 900 illustrating switching logic between Phone and Hearing modes, according to embodiments of the invention is described. In one or more embodiments, in an idle mode 904, computing device may be configured not to receive communications by an individual and/or a user. In one or more embodiments, logic system 900 may be switched from an idle mode 904 to a phone mode 908 or a hearing mode 912. In In one or more embodiments, a push button may be used to switch between an idle mode, phone mode and/or hearing mode 912. In one or more embodiments, various occurrences may automatically cause a switch between modes. For example, and without limitation, receipt of a phone call may trigger a phone mode 908 without any other input by a user. Similarly, hanging up the phone may switch between phone mode 908 and hearing mode 912. In various embodiments, signal processing algorithms run on a Bluetooth communication chip set(s). In various embodiments multiple signal processing algorithms are used. One algorithm running under “Hearing” and the other algorithm running under “Phone” modes are illustrated, their operations and flows are shown in FIG. 7A and FIG. 8, respectively. For the “Hearing” mode, the speech signals are received with a directional Microphone (which can be located on either the left or right temple). In an example where the directional microphone is located on the left temple, the speech signals are received by the directional microphone, amplified, and the amplified signal are output to the right temple loudspeaker. In the case where the directional microphone is located on the right temple, the amplified speech will be output to the left temple loudspeaker. As all signal processing algorithms are running on the electronic component's resident in the smart glasses body, such as in one or more temples or temple insert modules, under “Hearing” mode, the smart glasses body can be treated as hearing assist device which does not need to connect to any mobile terminal for operation. For Real-time language translation, in one non-limiting example, the speech signals are received by the directional Microphone (located on left temple), the speech signal are then processed using the electronics within a temple(s) and are then transmitted to the mobile phone. The mobile phone application will utilize a cloud-based AI system to perform real-time translation of the speech from language 1 to language 2 and send the signal back to the smart glasses for playback to the user. In some embodiments, when the directional microphone is located on a right temple, the amplified speech will be output to a left temple loudspeaker.

In various embodiments, the teaching presented herein provides interfaces between a user, smart glasses body, and the Cloud. In some embodiments, temporary storage of sensor data is provided before it is uploaded to the Cloud. In various embodiments, under “Phone” mode, the mobile terminal will perform the following tasks, such as, but not limited to; making and receiving phone call; playback music, voice messages, etc.

In various embodiments, under “Hearing” mode, the mobile terminal will perform different tasks depending on user's setting. As one non-limiting example, for a setting of real-time translation: (i.e. FIG. 7B), the mobile terminal will perform the following tasks, referring to FIG. 7C: Receive language 1 speech signal from smart glasses body; If “Speech-to-text” flag equals to TRUE then Mobile terminal performs speech-to-text operation to convert language 1 speech to language 1 text. Mobile terminal sends language 1 text to cloud for translation. ELSE—Mobile terminal sends language 1 speech to cloud for translation. After receiving translated language 2 text from cloud, the mobile terminal will perform text-to-speech to convert language 2 text and language 2 speech. The translated language to speech will then play back to smart glasses body and/or eyewear frame. As one non-limiting example, for a setting of “hearing assist,” for example FIG. 7A, the mobile terminal will perform the following tasks, referring to FIG. 7C: Receive amplified speech signal from microphone located at left/right temple of smart glasses body, and send the amplified speech signal to loudspeaker located at another side of temple (e.g. if microphone is on a left side temple, amplified speech will be output to a loudspeaker located in a right side temple.

In various embodiments, Real-time speech translation is provided by the systems described herein. In non-limiting examples, given only for illustration and with no limitation implied thereby, translate either language 1 speech to language 2 text or translate language 1 text to language 2 text and then send back the translated text to mobile terminal. In various embodiments, all or some of the sensor data captured by smart glasses is stored on database.

In various embodiments, the Open-ear smart glasses eco-system with hearing assistance functions is shown in FIG. 2. Eyewear device as described in reference to FIG. 1 may be consistent with the Open-ear smart glasses eco-system. In one or more embodiments, the open-ear hearing assistance smart glasses have only one open speaker output under “Hearing” mode. In one or more embodiments, the Open-ear hearing glasses contains hardware architecture as shown in FIG. 3.

In various embodiments, the microphone as described in reference to FIG. 3 is a directional microphone which captures speech signals at the front of the wearer.

In one or more embodiments, in the “Hearing” mode, if the directional microphone of the smart glasses is located on left temple, the amplified speech signals are output to the right temple loudspeaker only. In the case where the directional microphone is located on the right temple, the amplified speech will be output to the loudspeaker in the left temple.

In one or more embodiments, for the “Hearing” mode, the smart glasses can amplify speech signals received from the front of wearer independently without connection to any mobile terminal devices.

In one or more embodiments, the hearing assistance smart glasses consists of 2 modes of operations, the two modes are: a.) Hearing mode: audio beam points to the front, directional microphone captures speech signal from the front; and b.) Phone mode: captures speech signal from a user's mouth. Directional microphone captures speech signal downward.

In various embodiments, a signal processing algorithm is implemented as shown under “Hearing Mode” in FIG. 7A. Hearing mode may use case scenario 1: Capture speech signals from the front, processing and amplify the speech and then output the amplified signal to smart glasses speaker. Such functionality helps a user experiencing mild hearing loss to hear better (FIG. 7A).

In various embodiments, non-limiting examples of signal processing algorithms under “Phone Mode” are shown in FIG. 8.

In various embodiments, non-limiting examples of Real-time language translation under “Hearing Mode” are shown in FIG. 7B. For example, Smart glasses capture language 1 speech signals from the front, the language 1 speech signals will then be transmitted wirelessly to a mobile terminal and then wirelessly communicated to the Cloud for translation. The translated speech signals (e.g., English to Chinese) are sent send back wirelessly to the smart glasses. The translated speech signals are finally output to one or more loudspeaker(s) in the smart glasses. Such functionality helps a user to understand the content of speech from a speaker of a different language.

A non-limiting example, an embodiment of auto switching logic between “Phone” and “Hearing” modes is shown in FIG. 9. A manual switch may be located on eyewear device wherein the manual switch may allow for a switching between “Phone” and “Hearing” modes if smart glasses is on “idle” state. A real button or virtual button (touch sensor) may exist to toggle between “Phone” and “Hearing” modes. For example, if Smart glasses is on “Phone” mode, button press will change the Smart glasses from “Phone” to “Hearing” mode. Another button-press will change back to “Phone” mode. In one or more embodiments, eyewear device 100 as described in reference to FIG. 1, may contain auto switching logic wherein eyewear device may automatically navigate between several modes. For example, and without limitation, upon receipt of a phone call, eyewear device may switch from a first mode (also known as a hearing mode) to a second mode (also known as phone mode). In one or more embodiments, several modes may exist such as idle mode 904, phone mode 908 and hearing mode 912. In one or more embodiments, computing device 148 may be configured to switch between modes upon the occurrence of one or more predefined events. In one or more embodiments, predefined event may include interaction of user input device 136 as described in reference to FIG. 1. In one or more embodiments, predefined event may include receipt of a phone call, termination of a phone call, a button press and the like. In one or more embodiments, eyewear device 100 may transition between phone mode 908 and hearing mode 912 upon the occurrence of a phone call, video call and the like wherein initiation of the call may cause for a phone mode 908 and termination of the call may indicate for hearing mode to occur. In one or more embodiments, a transition between differing modes may occur upon the occurrence of pressing a button, wherein a first press may indicate a first mode, a second press may indicate a second mode and a third press may indicate a third mode.

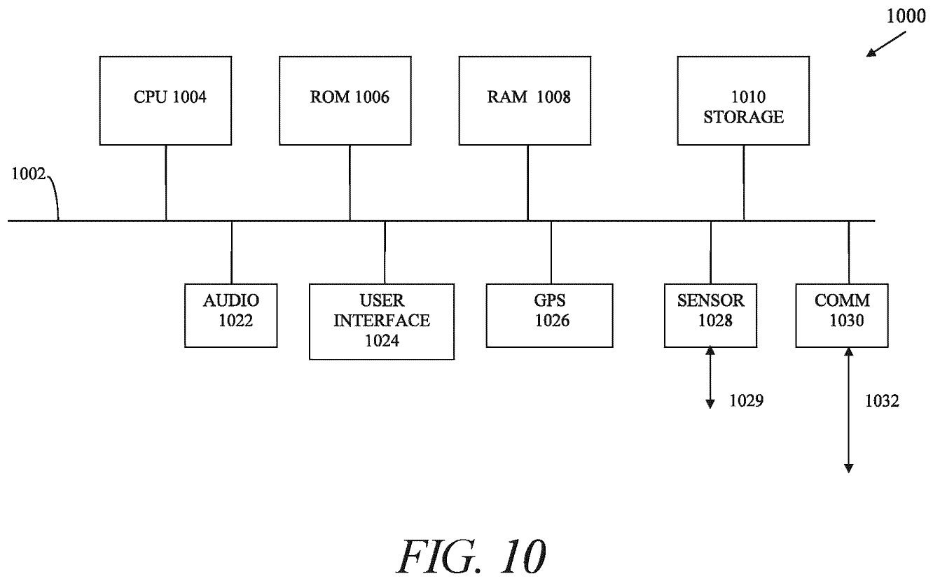

FIG. 10 illustrates, generally at 1000, a block diagram of smart glasses electronic hardware components, according to embodiments of the invention. In one or more embodiments, eyewear device as described within FIG. 1, may include smart glasses hardware components. With reference to FIG. 10, as used in this description of embodiments, smart glasses electronic hardware components can be based on a device such as a computer, in which embodiments of the invention may be used. The block diagram is a high-level conceptual representation and may be implemented in a variety of ways and by various architectures. Bus system 1002 interconnects a Central Processing Unit (CPU, MCU, DSP, MCU/DSP, etc.) 1004 (alternatively referred to herein as a processor(s)), Read Only Memory (ROM) 1006, Random Access Memory (RAM) 1008, storage 1010, audio 1022, user interface 1024, and communications 1030. RAM 1008 can also represent dynamic random-access memory (DRAM) or other forms of memory. The user interface 1024 can be in various embodiments a voice interface, a touch interface, a physical button, or combinations thereof. It is understood that memory (not shown) can be included with the CPU block 1004. The bus

system 1002 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 10104 (FireWire), Universal Serial Bus (USB), universal asynchronous receiver-transmitter (UART), serial peripheral interface (SPI), inter-integrated circuit (I2C), etc. The CPU 1004 may be a single, multiple, or even a distributed computing resource. Storage 1010 may be flash memory, etc. Note that depending upon the actual implementation of the smart glasses electronic hardware components, the suite of components may include some, all, more, or a rearrangement of components in the block diagram. Thus, many variations on the system of FIG. 10 are possible.

With continued reference to FIG. 10, connection with one or more wireless networks 1032 may be obtained via communication (COMM) 1030, which enables the smart glasses electronic hardware components 1000 to communicate wirelessly with local sensors, local devices, as well as with remote devices on remote networks. In some embodiments, 1032/1030 provide access to remote voice-to-text conversion systems and/or language translation systems which can be in remote locations, for example Cloud based. 1032 and 1030 flexibly represent wireless communication systems in various implementations, and can represent various forms of telemetry, general packet radio service (GPRS), Ethernet, Wide Area Network (WAN), Local Area Network (LAN), Internet connection, Wi-Fi, WiMAX, ZigBee, Infrared, Bluetooth, near-field communications, mobile telephone communications systems, such as 3G, 4G, LTE, 5G, etc. and combinations thereof. In various embodiments, a touch interface is optionally provided at 1024. Signals from one or more sensors are input to the system via 10210 and 1028. Global position system (GPS) information is received and is input to the system at 1026. Audio can represent a speaker such as a projection speaker or projection micro-speaker described herein.

In various embodiments, depending on the hardware configuration, different wireless protocols are used in the networks to provide the systems described in the figures above. One non-limiting embodiment of a technology used for wireless signal transmission is the Bluetooth wireless technology standard which is also commonly known as IEEE 802.15.1 standard. In other embodiments, the wireless signal transmission protocol known as Wi-Fi is used which uses the IEEE 802.11 standard. In other embodiments, the ZigBee communication protocol is used which is based on the IEEE 802.15.4 standard. These examples are given merely for illustration and do not limit different embodiments. Transmission Control Protocol (TCP) and Internet Protocol (IP) are also used with different embodiments. Embodiments are not limited by the data communication protocols listed herein and are readily used with other data communication protocols not specifically listed herein.

In various embodiments, the components of systems as well as the systems described in the previous figures are implemented in an integrated circuit device, which may include an integrated circuit package containing the integrated circuit. In some embodiments, the components of systems as well as the systems are implemented in a single integrated circuit die. In other embodiments, the components of systems as well as the systems are implemented in more than one integrated circuit die of an integrated circuit device which may include a multi-chip package containing the integrated circuit.

In one or more embodiments, the electronics system of a head wearable device is distributed across a left temple, a front frame, and a right temple. In one or more embodiments, a left temple houses a battery, one or more microphones, and at least one speaker. A right temple houses a battery, system electronics, one or microphones, and at least one speaker. In some embodiments, electrical connections between components of the system (temples and front frame) are provided in the form of removable connectors. In some embodiments, these connectors can be hinged. In yet other embodiments, left and right temples of a pair of smart glasses communicate with each other wirelessly without wired connection therebetween.

For purposes of discussing and understanding the different embodiments, it is to be understood that various terms are used by those knowledgeable in the art to describe techniques and approaches. Furthermore, in the description, for purposes of explanation, numerous specific details are set forth in order to provide a thorough understanding of an embodiment. It will be evident, however, to one of ordinary skill in the art that an embodiment may be practiced without these specific details. In some instances, well-known structures and devices are shown in block diagram form, rather than in detail, in order to avoid obscuring various embodiments. These embodiments are described in sufficient detail to enable those of ordinary skill in the art to practice the invention, and it is to be understood that other embodiments may be utilized, and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be noted, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), dynamic random access memories (DRAM), electrically programmable read-only memories (EPROM)s, electrically erasable programmable read-only memories (EEPROMs), FLASH memories, magnetic or optical cards, RAID, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the embodiments can be implemented in hard-wired circuitry, by programming a general-purpose processor, or by any combination of hardware and software. One of ordinary skill in the art will immediately appreciate that the embodiments can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The embodiments can also be practiced in distributed computing environments where tasks are performed by remote processing devices that are linked through a communications network.

The methods herein may be implemented using computer software. If written in a programming language conforming to a recognized standard, sequences of instructions designed to implement the methods can be compiled for execution on a variety of hardware platforms and for interface to a variety of operating systems. In addition, the embodiments are not described with reference to any particular programming language. It will be appreciated that a variety of programming languages may be used to implement the teachings of the embodiments as described herein. Furthermore, it is common in the art to speak of software, in one form or another (e.g., program, procedure, application, driver, and the like), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical representation in at least hardware and/or software (such as a computer system in which the techniques of the present invention may be practiced as well as implemented as an embodiment).

Non-transitory machine-readable media is understood to include any mechanism for storing information (such as program code, etc.) in a form readable by a machine (e.g., a computer). For example, a machine-readable medium, synonymously referred to as a computer readable medium, includes read only memory (ROM); random access memory (RAM); magnetic disk storage media; optical storage media; flash memory devices; except electrical, optical, acoustical or other forms of transmitting information via propagated signals (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described but can be practiced with modification and alteration. The description is thus to be regarded as illustrative instead of limiting.

Referring now to FIG. 11, an exemplary embodiment of a machine-learning module 1100 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1104 to generate an algorithm instantiated in hardware or software logic, data structures, and/or functions that will be performed by a computing device/module to produce outputs 1108 given data provided as inputs 1112; this is in contrast to a non-machine learning software program where the commands to be executed are determined in advance by a user and written in a programming language.

Still referring to FIG. 11, “training data,” as used herein, is data containing correlations that a machine-learning process may use to model relationships between two or more categories of data elements. For instance, and without limitation, training data 1104 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1104 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1104 according to various correlations; correlations may indicate causative and/or predictive links between categories of data elements, which may be modeled as relationships such as mathematical relationships by machine-learning processes as described in further detail below. Training data 1104 may be formatted and/or organized by categories of data elements, for instance by associating data elements with one or more descriptors corresponding to categories of data elements. As a non-limiting example, training data 1104 may include data entered in standardized forms by persons or processes, such that entry of a given data element in a given field in a form may be mapped to one or more descriptors of categories. Elements in training data 1104 may be linked to descriptors of categories by tags, tokens, or other data elements; for instance, and without limitation, training data 1104 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 11, training data 1104 may include one or more elements that are not categorized; that is, training data 1104 may not be formatted or contain descriptors for some elements of data. Machine-learning algorithms and/or other processes may sort training data 1104 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1104 to be made applicable for two or more distinct machine-learning algorithms as described in further detail below. Training data 1104 used by machine-learning module 1100 may correlate any input data as described in this disclosure to any output data as described in this disclosure. As a non-limiting illustrative example inputs may include inputs such as communication text and/or translated communication text and outputs may include outputs such as modified communication text.

Further referring to FIG. 11, training data may be filtered, sorted, and/or selected using one or more supervised and/or unsupervised machine-learning processes and/or models as described in further detail below; such models may include without limitation a training data classifier 1116. Training data classifier 1116 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1100 may generate a classifier using a classification algorithm, defined as a processes whereby a computing device and/or any module and/or component operating thereon derives a classifier from training data 1104. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1116 may classify elements of training data to topics and/or separate sentences such as education, recent events, medicine, politics and the like. in one or more embodiments, a particular grouping of words within a particular topic may require modification different from that of a different topic. In one or more embodiments, elements of communication text and/or translated communication text may be grouped based on topics, sentences and the like.

Still referring to FIG. 11, computing device 1104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)+P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naive Bayes algorithm may be generated by first transforming training data into a frequency table. Computing device 1104 may then calculate a likelihood table by calculating probabilities of different data entries and classification labels. Computing device 1104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 11, computing device 1104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 11, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 11, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or another device, or the like.

Continuing to refer to FIG. 11, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 11, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 11, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 11, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 11, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 11, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 11, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Still referring to FIG. 11, machine-learning module 1100 may be configured to perform a lazy-learning process 1120 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1104. Heuristic may include selecting some number of highest-ranking associations and/or training data 1104 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 11, machine-learning processes as described in this disclosure may be used to generate machine-learning models 1124. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1124 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1124 may be generated by creating an artificial neural network, such as a convolutional neural network comprising an input layer of nodes, one or more intermediate layers, and an output layer of nodes. Connections between nodes may be created via the process of “training” the network, in which elements from a training data 1104 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 11, machine-learning algorithms may include at least a supervised machine-learning process 1128. At least a supervised machine-learning process 1128, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs such as but not limited to communication text as described above as inputs, outputs such as modified communication text as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1104. Persons skilled in the art, upon reviewing the entirety of this disclosure, will be aware of various possible variations of at least a supervised machine-learning process 1128 that may be used to determine relation between inputs and outputs. Supervised machine-learning processes may include classification algorithms as defined above.

With further reference to FIG. 11, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 11, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 11, machine learning processes may include at least an unsupervised machine-learning processes 1132. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1132 may not require a response variable; unsupervised processes 1132 may be used to find interesting patterns and/or inferences between variables, to determine a degree of correlation between two or more variables, or the like.

Still referring to FIG. 11, machine-learning module 1100 may be designed and configured to create a machine-learning model 1124 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 11, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 11, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 11, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 11, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 11, one or more processes or algorithms described above may be performed by at least a dedicated hardware unit 1136. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1136 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1136 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1136 to perform one or more operations described herein, such as evaluation of model and/or algorithm outputs, one-time or iterative updates to parameters, coefficients, weights, and/or biases, and/or any other operations such as vector and/or matrix operations as described in this disclosure.

Referring now to FIG. 12, an exemplary embodiment of neural network 1200 is illustrated. A neural network 1200 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1204, one or more intermediate layers 1208, and an output layer of nodes 1212. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

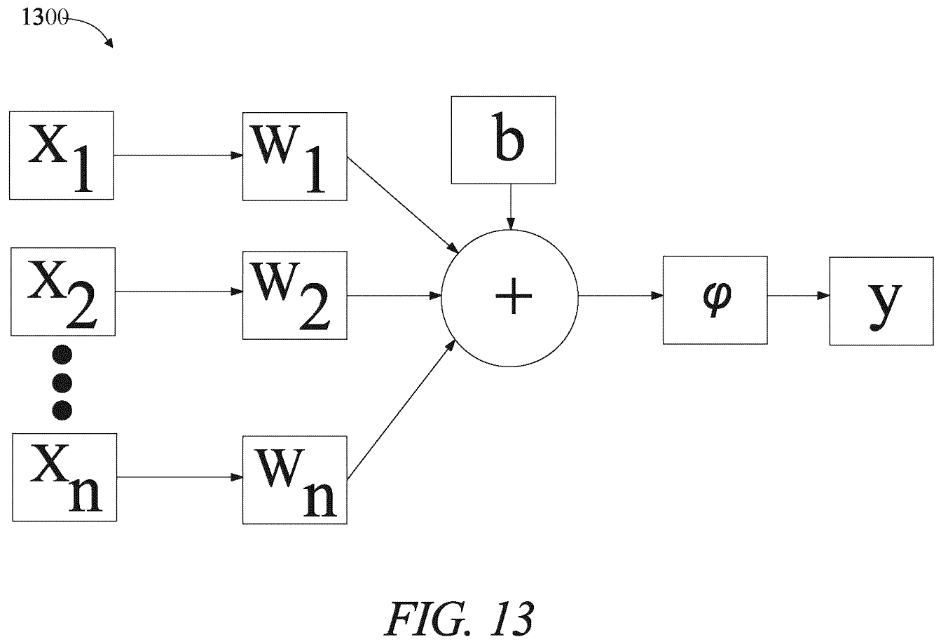

Referring now to FIG. 13, an exemplary embodiment of a node 1300 of a neural network is illustrated. A node may include, without limitation, a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation, functions may include, without limitation, a sigmoid function of the form

$$f ( x ) = \frac{1}{1 - {e}^{- x}}$$

given input xᵢ a tanh (hyperbolic tangent) function, of the form e^{x}−e^{-x}/e^{x}+e^{-x}, a tanh derivative function such as f(x)=tanh²(x), a rectified linear unit function such as f(x)=max (0, x), a “leaky” and/or “parametric” rectified linear unit function such as f(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh (\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

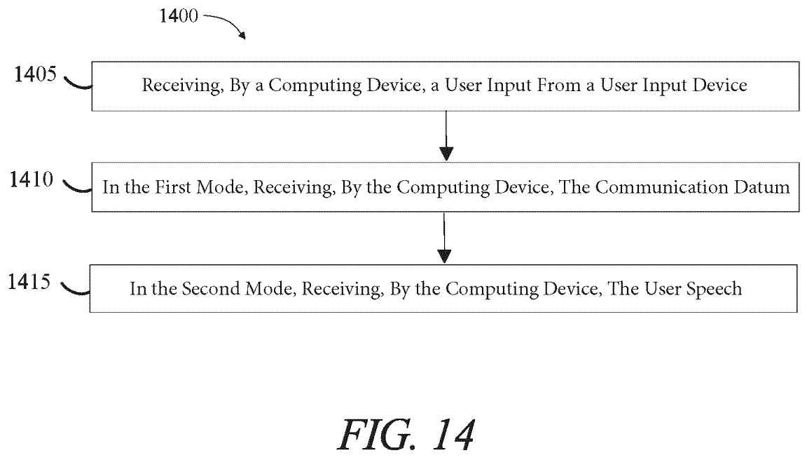

Referring now to FIG. 14, a method 1400 of use for an eyewear device is described. In one or more embodiments, at step 1405, method 1400 includes receiving, by a computing device communicatively connected to the eyewear device, a user input from a user input device located on an eyewear frame of the eyewear device. The eyewear frame includes a first unidirectional audio input device configured to receive a communication datum associated with an individual in communication with the user, a second unidirectional audio input device configured to receive a user speech from the user and the user input device, the user input device configured to control whether the eye frame is in a first mode or a second mode. In one or more embodiments, the eyewear frame includes optical lenses. In one or more embodiment, the user input device includes a capacitive sensor. This may be implemented with reference to FIGS. 1-14 and without limitation.

With continued reference to FIG. 14, at step 1410 method 1400 includes in the first mode, receiving, by the computing device, the communication datum from the first unidirectional audio input device and modifying the communication datum to generate a modified communication datum. I one or more embodiments, the eyewear frame further includes a proximity sensor configured to detect at least the presence of a user and receiving, by the computing device, the communication datum includes receiving a presence datum from at least the proximity sensor and receiving the communication datum as a function of the presence datum. In one or more embodiments, modifying the communication datum to generate the modified communication datum includes receiving communication training data having a plurality of communication data correlated to a plurality of modified communication data, training a communication machine learning model as a function of the communication training data and generating the modified communication datum as a function of the communication machine learning model. In one or more embodiments, in the first mode, the second audio directional input device is disabled, and in a second mode, the first unidirectional audio input device is disabled. In one or more embodiments, the method further includes in the first mode, transmitting, by the computing device, the modified communication datum to the audio output device. In one or more embodiments, modifying the communication datum as a function of user input to generate a modified communication datum includes converting the communication datum into a communication text wherein the communication text comprises textual data, transmitting the communication text to a server and receiving a modified communication datum from the server database as a function of the communication text. In one or more embodiments, the modified communication datum includes a translated communication text. In one or more embodiments, the method further includes switching, by the computing device, from the second mode to the first mode upon termination of a voice call. This may be implemented with reference to FIGS. 1-14 and without limitation.

With continued reference to FIG. 14, at step 1415, method 1400 includes in the second mode, receiving, by the computing device, the user speech from the second unidirectional audio input device and transmitting the user speech to a remote device. This may be implemented with reference to FIGS. 1-14 and without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

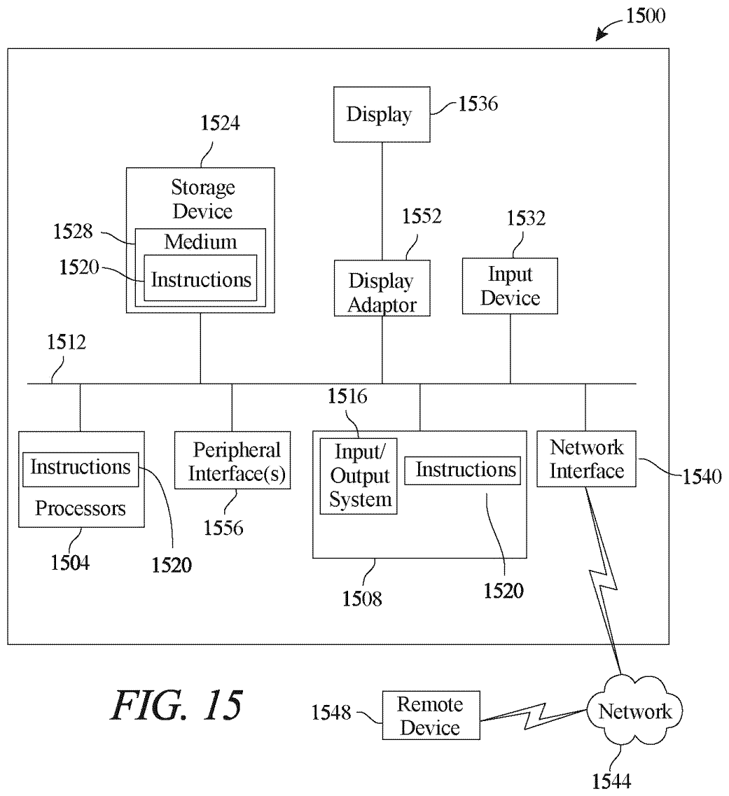

FIG. 15 shows a diagrammatic representation of one embodiment of a computing device in the exemplary form of a computer system 1500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Processor 1504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1504 may be organized according to Von Neumann and/or Harvard architecture as a non-limiting example. Processor 1504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), system on module (SOM), and/or system on a chip (SoC).

Memory 1508 may include various components (e.g., machine-readable media) including, but not limited to, a random-access memory component, a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive, a magnetic disk drive, an optical disc drive in combination with an optical medium, a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable medium 1528 may provide nonvolatile and/or volatile storage of machine-readable instructions, data structures, program modules, and/or other data for computer system 1500. In one example, software 1520 may reside, completely or partially, within machine-readable medium 1528. In another example, software 1520 may reside, completely or partially, within processor 1504.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540, may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide graphical representations of aspects of the present disclosure. In addition to a display device, computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, apparatuses, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A smart eyewear device system comprising:
an eyewear device comprising:
a first unidirectional audio input device configured to receive a communication datum from an individual in communication with a user;
a second unidirectional audio input device configured to receive user speech from the user;
a user input device configured to control whether the eyewear frame is in a first mode or a second mode;
at least one audio output device located on at least one temple of the eyewear device;
a computing device configured to:
receive a user input from the user input device;
in the first mode, receive the communication datum from the first unidirectional audio input device; and
in the second mode, receive the user speech from the second unidirectional audio input device and transmit the user speech; and
a remote device communicatively connected to the eyewear device and a cloud server, the remote device configured to receive the communication datum and the user speech from the computing device.

2. The smart eyewear device system of claim 1, wherein computing device is further configured to amplify the communication datum and transmit the amplified communication datum to the at least one audio output device.

3. The smart eyewear device system of claim 2, wherein the at least one audio output device is further configured to output the amplified communication datum.

4. The smart eyewear device system of claim 1, wherein the first unidirectional audio input device comprises a unidirectional microphone configured to receive the communication datum along a line of sight of the user.

5. The smart eyewear device system of claim 1, wherein the remote device is further configured to:
convert the communication datum into communication text;
transmit the communication text to the cloud server; and
receive a modified communication text from the cloud server as a function of the communication text.

6. The smart eyewear device system of claim 5, wherein the remote device is further configured to convert the modified communication text into a modified communication datum.

7. The smart eyewear device system of claim 1, wherein in the first mode, the computing device is further configured to output a modified communication datum to a selected audio output device of the at least one audio output device.

8. The smart eyewear device system of claim 6, the first unidirectional audio input device is disposed on a first temple of the at least one temple.

9. The smart eyewear device system of claim 7, wherein the selected audio output device comprises the at least one audio output device disposed on a second temple of the at least one temple.

10. The smart eyewear device system of claim 1, wherein the eyewear device is directly communicatively connected to the cloud server.

11. An eyewear device comprising:
an eyewear frame comprising:
a first unidirectional audio input device configured to receive a communication datum from an individual in communication with a user;
a second unidirectional audio input device configured to receive user speech from the user;
a user input device configured to control whether the eyewear frame is in a first mode or a second mode; and
at least one audio output device located on at least one temple of the eyewear frame; and
a computing device communicatively connected to the eyewear device; the computing device configured to:
receive a user input from the user input device;
in the first mode, receive the communication datum from the first unidirectional audio input device and modify the communication datum to generate a modified communication datum; and
in the second mode, receive the user speech from the second unidirectional audio input device and transmit the user speech to a remote device.

12. The eyewear device of claim 11, wherein the eyewear frame further comprises optical lenses.

13. The eyewear device of claim 11, wherein:
the eyewear frame further comprises a proximity sensor configured to detect at least the presence of a user; and
receiving the communication datum comprises:
receiving a presence datum from at least the proximity sensor; and
receiving the communication datum as a function of the presence datum.

14. The eyewear device of claim 11, wherein modifying the communication datum to generate the modified communication datum comprises:
receiving communication training data having a plurality of communication data correlated to a plurality of modified communication data;
training a communication machine learning model as a function of the communication training data;
generating the modified communication datum as a function of the communication machine learning model.

15. The eyewear device of claim 11, wherein the user input device comprises a capacitive sensor.

16. The eyewear device of claim 11, wherein in the first mode, the second unidirectional audio input device is disabled, and in the second mode, the first unidirectional audio input device is disabled.

17. The eyewear device of claim 11, wherein the computing device is configured to, in a first mode, transmit the modified communication datum to the audio output device.

18. The eyewear device of claim 11, wherein modifying the communication datum to generate a modified communication datum comprises:
converting the communication datum into communication text wherein the communication text comprises textual data;
transmitting the communication text to a server; and
receiving a modified communication datum from the server as a function of the communication text.

19. The eyewear device of claim 18, wherein receiving the modified communication datum comprises:
determining a communication language; and
comparing the communication language to a desired language; and
generating a translated communication datum for the modified communication datum as a function of the communication language and the desired language.

20. The eyewear device of claim 19, wherein computing device is further configured to receive the translated communication datum and output the translated communication datum using the at least one audio output device.

21. The eyewear device of claim 11, wherein the computing device is configured to switch from the second mode to the first mode as a function of a termination of a voice call.

22. A method of use for an eyewear device, the method comprising:
receiving, by a computing device communicatively connected to the eyewear device, a user input from a user input device located on an eyewear frame of the eyewear device, wherein the eyewear frame comprises:
a first unidirectional audio input device configured to receive a communication datum associated with an individual in communication with the user;
a second unidirectional audio input device configured to receive a user speech from the user;
the user input device, the input device configured to control whether the eyewear frame is in a first mode or a second mode; and
at least one audio output device located on at least one temple of the eyewear frame;
in the first mode, receiving, by the computing device, the communication datum from the first unidirectional audio input device and modifying the communication datum to generate a modified communication datum; and
in the second mode, receiving, by the computing device, the user speech from the second unidirectional audio input device and transmitting the user speech to a remote device.

23. The method of claim 22, wherein the eyewear frame further comprises optical lenses.

24. The method of claim 22, wherein:
the eyewear frame further comprises a proximity sensor configured to detect at least the presence of a user; and
receiving, by the computing device, the communication datum comprises:
receiving a presence datum from at least the proximity sensor; and
receiving the communication datum as a function of the presence datum.

25. The method of claim 22, wherein modifying the communication datum to generate the modified communication datum comprises:
receiving communication training data having a plurality of communication data correlated to a plurality of modified communication data;
training a communication machine learning model as a function of the communication training data;
generating the modified communication datum as a function of the communication machine learning model.

26. The method of claim 22, wherein the user input device comprises a capacitive sensor.

27. The method of claim 22, wherein in the first mode, the second audio directional input device is disabled, and in a second mode, the first unidirectional audio input device is disabled.

28. The method of claim 22, further comprising, in the first mode, transmitting, by the computing device, the modified communication datum to the audio output device.

29. The method of claim 22, wherein modifying the communication datum as a function of user input to generate a modified communication datum comprises:
converting the communication datum into a communication text wherein the communication text comprises textual data;
transmitting the communication text to a server; and
receiving a modified communication datum from the server as a function of the communication text.

30. The method of claim 29, wherein the modified communication datum comprises a translated communication datum.

31. The method of claim 30, further comprising:
receiving, by the computing device, the translated communication datum; and
outputting, by the at least one audio output device, the translated communication datum.

32. The method of claim 21, further comprising switching, by the computing device, from the second mode to the first mode upon termination of a voice call.
